(19) United States
(12) Patent Application Publication
(10) Pub. No.: US 2024/0251391 A1
(43) Pub. Date: Jul. 25, 2024

(54) Transmission Power Adjustment

(71) Applicant: Comcast Cable Communications, LLC, Philadelphia, PA (US)

(72) Inventors: Alireza Babaei, Fairfax, VA (US); Esmael Hejazi Dinan, McLean, VA (US)

(21) Appl. No.: 18/601,630

(22) Filed: Mar. 11, 2024

Related U.S. Application Data
(63) Continuation of application No. 17/470,653, filed on Sep. 9, 2021, now Pat. No. 11,963,145.
Application No. 17/470,653 is a continuation of application No. 15/784,716, filed on Oct. 16, 2017, now Pat. No. 11,147,062.
(60) Provisional application No. 62/408,373, filed on Oct. 14, 2016.
(60) Provisional application No. 62/408,338, filed on Oct. 14, 2016.

(51) Int. Cl. H04W 72/0446; H04W 52/14; H04W 52/34; H04W 72/23; H04W 74/0808

(52) U.S. Cl. CPC H04W 72/0446; H04W 52/146; H04W 52/34; H04W 52/346; H04W 74/0808; H04W 72/23

(57) ABSTRACT

A wireless device may be configured to support dual connectivity with multiple cell groups. Time durations of the cell groups may overlap. A message may indicate a minimum amount of time for a wireless device to perform a power adjustment. A configuration message may indicate a threshold timing difference between overlapping time durations of the cell groups for performing power adjustment.

### CROSS-REFERENCE TO RELATED APPLICATIONS

This application is a continuation of U.S. patent application Ser. No. 17/470,653, filed Sep. 9, 2021, which is a continuation of U.S. application Ser. No. 15/784,716, filed Oct. 16, 2017 (now U.S. Pat. No. 11,147,062), which claims the benefit of both U.S. Provisional Application No. 62/408,338, filed Oct. 14, 2016, and U.S. Provisional Application No. 62/408,373, filed Oct. 14, 2016, each of which is hereby incorporated by reference herein in its entirety.

### BRIEF DESCRIPTION OF THE SEVERAL VIEWS OF THE DRAWINGS

Examples of several of the various embodiments of the present disclosure are described herein with reference to the drawings.

FIG. 1 is a diagram depicting example sets of OFDM subcarriers as per an aspect of an embodiment of the present disclosure.

FIG. 2 is a diagram depicting an example transmission time and reception time for two carriers in a carrier group as per an aspect of an embodiment of the present disclosure.

FIG. 3 is an example diagram depicting OFDM radio resources as per an aspect of an embodiment of the present disclosure.

FIG. 4 is an example block diagram of a base station and a wireless device as per an aspect of an embodiment of the present disclosure.

FIG. 5A, FIG. 5B, FIG. 5C and FIG. 5D are example diagrams for uplink and downlink signal transmission as per an aspect of an embodiment of the present disclosure.

FIG. 6 is an example diagram for a protocol structure with CA and DC as per an aspect of an embodiment of the present disclosure.

FIG. 7 is an example diagram for a protocol structure with CA and DC as per an aspect of an embodiment of the present disclosure.

FIG. 8 shows example TAG configurations as per an aspect of an embodiment of the present disclosure.

FIG. 9 is an example message flow in a random access process in a secondary TAG as per an aspect of an embodiment of the present disclosure.

FIG. 10 is an example diagram depicting a downlink burst as per an aspect of an embodiment of the present disclosure.

FIG. 11 depicts examples of activation/deactivation MAC control element as per an aspect of an embodiment of the present disclosure.

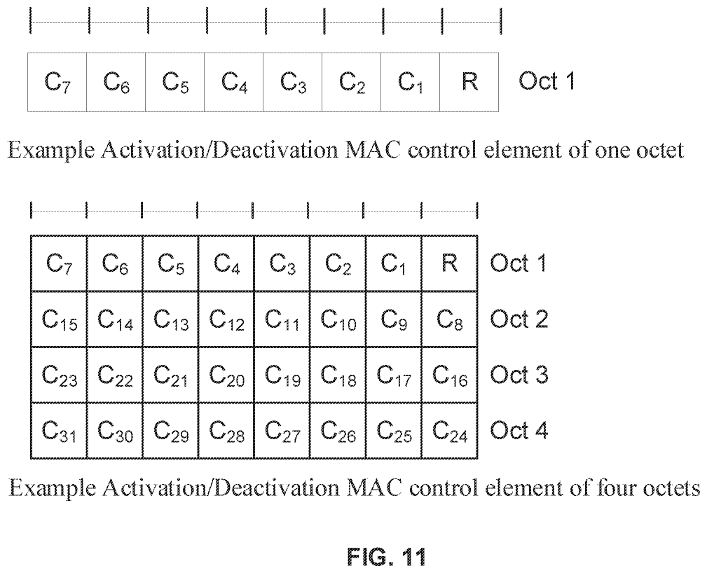

FIG. 12 is an example diagram depicting trigger A and trigger B in a 2-stage triggered grant as per an aspect of an embodiment of the present disclosure.

FIG. 13 is an example timing relation between a first cell group and a second cell group as per an aspect of an embodiment of the present disclosure.

FIG. 14 is an example p-MeNB and p-SeNB values as per an aspect of an embodiment of the present disclosure.

FIG. 15 is an example signal transmission as per an aspect of an embodiment of the present disclosure.

FIG. 16 is an example master cell group and secondary cell group as per an aspect of an embodiment of the present disclosure.

FIG. 17 is an example signal transmission and listen before talk as per an aspect of an embodiment of the present disclosure.

FIG. 18 is an example signal transmission and listen before talk as per an aspect of an embodiment of the present disclosure.

FIG. 19 is an example timing relation between a first cell group and a second cell group as per an aspect of an embodiment of the present disclosure.

FIG. 20 is an example timing relation between subframes and grants as per an aspect of an embodiment of the present disclosure.

FIG. 21 is an example flow diagram as per an aspect of an embodiment of the present disclosure.

FIG. 22 is an example flow diagram as per an aspect of an embodiment of the present disclosure.

FIG. 23 is an example flow diagram as per an aspect of an embodiment of the present disclosure.

### DETAILED DESCRIPTION OF EMBODIMENTS

Example embodiments of the present disclosure enable operation of carrier aggregation. Embodiments of the technology disclosed herein may be employed in the technical field of multicarrier communication systems.

The following Acronyms are used throughout the present disclosure:
ASIC application-specific integrated circuit
BPSK binary phase shift keying
CA carrier aggregation
CSI channel state information
CDMA code division multiple access
CSS common search space
CPLD complex programmable logic devices
CC component carrier
DL downlink
DCI downlink control information
DC dual connectivity
EPC evolved packet core
E-UTRAN evolved-universal terrestrial radio access network
FPGA field programmable gate arrays
FDD frequency division multiplexing
HDL hardware description languages
HARQ hybrid automatic repeat request
IE information element
LAA licensed assisted access
LTE long term evolution
MCG master cell group
MeNB master evolved node B
MIB master information block
MAC media access control
MAC media access control
MME mobility management entity
NAS non-access stratum
OFDM orthogonal frequency division multiplexing
PDCP packet data convergence protocol
PDU packet data unit
PHY physical
PDCCH physical downlink control channel
PHICH physical HARQ indicator channel
PUCCH physical uplink control channel
PUSCH physical uplink shared channel
PCell primary cell
PCC primary component carrier
PSCell primary secondary cell
pTAG primary timing advance group
QAM quadrature amplitude modulation
QPSK quadrature phase shift keying
RBG Resource Block Groups
RLC radio link control
RRC radio resource control
RA random access
RB resource blocks
SCC secondary component carrier
SCell secondary cell
SCG secondary cell group
SeNB secondary evolved node B
sTAGs secondary timing advance group
SDU service data unit
S-GW serving gateway
SRB signaling radio bearer
SC-OFDM single carrier-OFDM
SFN system frame number
SIB system information block
TAI tracking area identifier
TAT time alignment timer
TDD time division duplexing
TDMA time division multiple access
TA timing advance
TAG timing advance group
TB transport block
UL uplink
UE user equipment
VHDL VHSIC hardware description language

Example embodiments of the disclosure may be implemented using various physical layer modulation and transmission mechanisms. Example transmission mechanisms may include, but are not limited to: CDMA, OFDM, TDMA, Wavelet technologies, and/or the like. Hybrid transmission mechanisms such as TDMA/CDMA, and OFDM/CDMA may also be employed. Various modulation schemes may be applied for signal transmission in the physical layer. Examples of modulation schemes include, but are not limited to: phase, amplitude, code, a combination of these, and/or the like. An example radio transmission method may implement QAM using BPSK, QPSK, 16-QAM, 64-QAM, 256-QAM, and/or the like. Physical radio transmission may be enhanced by dynamically or semi-dynamically changing the modulation and coding scheme depending on transmission requirements and radio conditions.

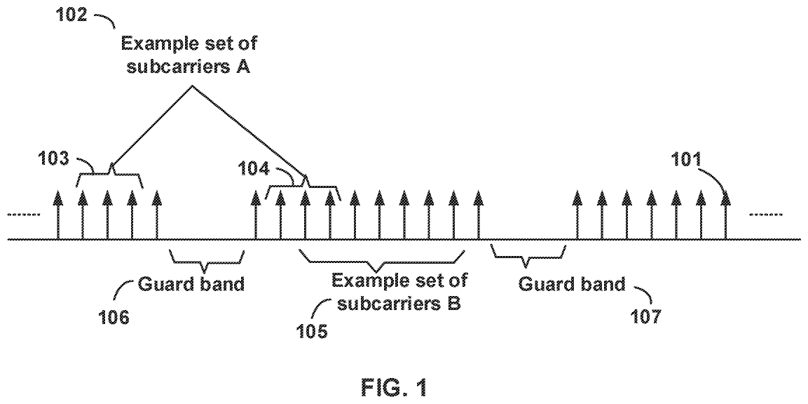

FIG. 1 is a diagram depicting example sets of OFDM subcarriers as per an aspect of an embodiment of the present disclosure. As illustrated in this example, arrow(s) in the diagram may depict a subcarrier in a multicarrier OFDM system. The OFDM system may use technology such as OFDM technology, DFTS-OFDM, SC-OFDM technology, or the like. For example, arrow 101 shows a subcarrier transmitting information symbols. FIG. 1 is for illustration purposes, and a typical multicarrier OFDM system may include more subcarriers in a carrier. For example, the number of subcarriers in a carrier may be in the range of 10 to 10,000 subcarriers. FIG. 1 shows two guard bands 106 and 107 in a transmission band. As illustrated in FIG. 1, guard band 106 is between subcarriers 103 and subcarriers 104. The example set of subcarriers A 102 includes subcarriers 103 and subcarriers 104. FIG. 1 also illustrates an example set of subcarriers B 105. As illustrated, there is no guard band between any two subcarriers in the example set of subcarriers B 105. Carriers in a multicarrier OFDM communication system may be contiguous carriers, non-contiguous carriers, or a combination of both contiguous and non-contiguous carriers.

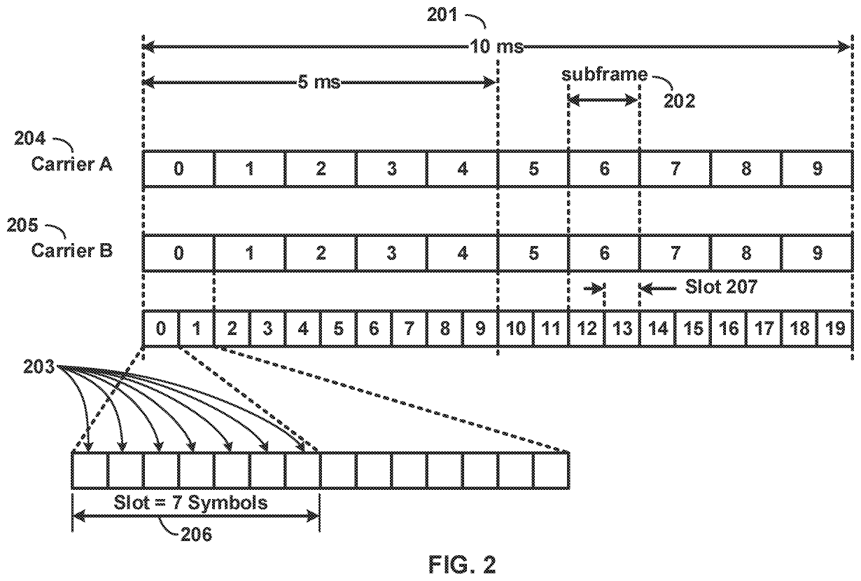

FIG. 2 is a diagram depicting an example transmission time and reception time for two carriers as per an aspect of an embodiment of the present disclosure. A multicarrier OFDM communication system may include one or more carriers, for example, ranging from 1 to 10 carriers. Carrier A 204 and carrier B 205 may have the same or different timing structures. Although FIG. 2 shows two synchronized carriers, carrier A 204 and carrier B 205 may or may not be synchronized with each other. Different radio frame structures may be supported for FDD and TDD duplex mechanisms. FIG. 2 shows an example FDD frame timing. Downlink and uplink transmissions may be organized into radio frames 201. In this example, the radio frame duration is 10 msec. Other frame durations, for example, in the range of 1 to 100 msec may also be supported. In this example, each 10 ms radio frame 201 may be divided into ten equally sized subframes 202. Other subframe durations such as 0.5 msec, 1 msec, 2 msec, and 5 msec may also be supported. Subframe(s) may consist of two or more slots (for example, slots 206 and 207). For the example of FDD, 10 subframes may be available for downlink transmission and 10 subframes may be available for uplink transmissions in each 10 ms interval. Uplink and downlink transmissions may be separated in the frequency domain. Slot(s) may include a plurality of OFDM symbols 203. The number of OFDM symbols 203 in a slot 206 may depend on the cyclic prefix length and subcarrier spacing.

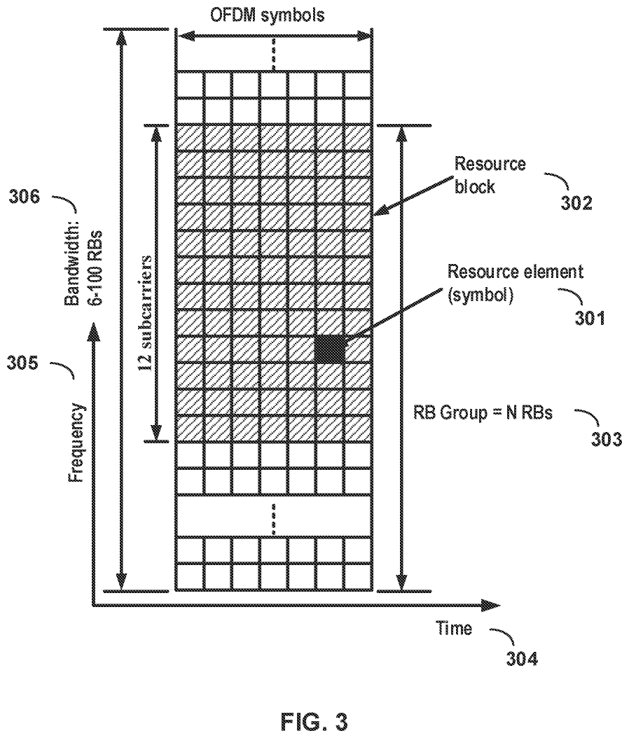

FIG. 3 is a diagram depicting OFDM radio resources as per an aspect of an embodiment of the present disclosure. The resource grid structure in time 304 and frequency 305 is illustrated in FIG. 3. The quantity of downlink subcarriers or RBs (in this example 6 to 100 RBs) may depend, at least in part, on the downlink transmission bandwidth 306 configured in the cell. The smallest radio resource unit may be called a resource element (e.g. 301). Resource elements may be grouped into resource blocks (e.g. 302). Resource blocks may be grouped into larger radio resources called Resource Block Groups (RBG) (e.g. 303). The transmitted signal in slot 206 may be described by one or several resource grids of a plurality of subcarriers and a plurality of OFDM symbols. Resource blocks may be used to describe the mapping of certain physical channels to resource elements. Other pre-defined groupings of physical resource elements may be implemented in the system depending on the radio technology. For example, 24 subcarriers may be grouped as a radio block for a duration of 5 msec. In an illustrative example, a resource block may correspond to one slot in the time domain and 180 kHz in the frequency domain (for 15 KHz subcarrier bandwidth and 12 subcarriers).

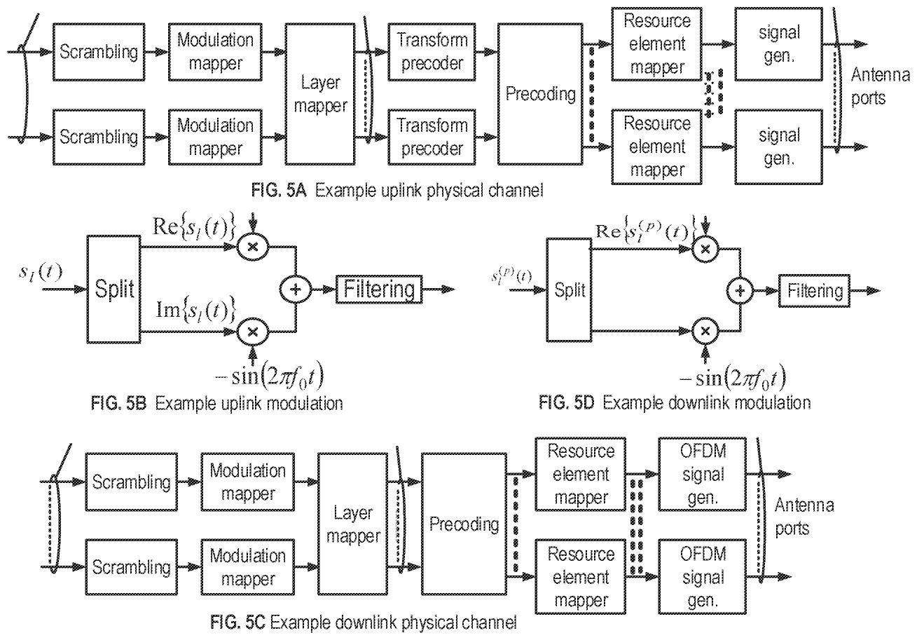

FIG. 5A, FIG. 5B, FIG. 5C and FIG. 5D are example diagrams for uplink and downlink signal transmission as per an aspect of an embodiment of the present disclosure. FIG. 5A shows an example uplink physical channel. The baseband signal representing the physical uplink shared channel may perform the following processes. These functions are illustrated as examples and it is anticipated that other mechanisms may be implemented in various embodiments. The functions may comprise scrambling, modulation of scrambled bits to generate complex-valued symbols, mapping of the complex-valued modulation symbols onto one or several transmission layers, transform precoding to generate complex-valued symbols, precoding of the complex-valued symbols, mapping of precoded complex-valued symbols to resource elements, generation of complex-valued time-domain DFTS-OFDM/SC-FDMA signal for each antenna port, and/or the like.

Example modulation and up-conversion to the carrier frequency of the complex-valued DFTS-OFDM/SC-FDMA baseband signal for each antenna port and/or the complex-valued PRACH baseband signal is shown in FIG. 5B. Filtering may be employed prior to transmission.

An example structure for Downlink Transmissions is shown in FIG. 5C. The baseband signal representing a downlink physical channel may perform the following processes. These functions are illustrated as examples and it is anticipated that other mechanisms may be implemented in various embodiments. The functions include scrambling of coded bits in each of the codewords to be transmitted on a physical channel; modulation of scrambled bits to generate complex-valued modulation symbols; mapping of the complex-valued modulation symbols onto one or several transmission layers; precoding of the complex-valued modulation symbols on each layer for transmission on the antenna ports; mapping of complex-valued modulation symbols for each antenna port to resource elements; generation of complex-valued time-domain OFDM signal for each antenna port, and/or the like.

Example modulation and up-conversion to the carrier frequency of the complex-valued OFDM baseband signal for each antenna port is shown in FIG. 5D. Filtering may be employed prior to transmission.

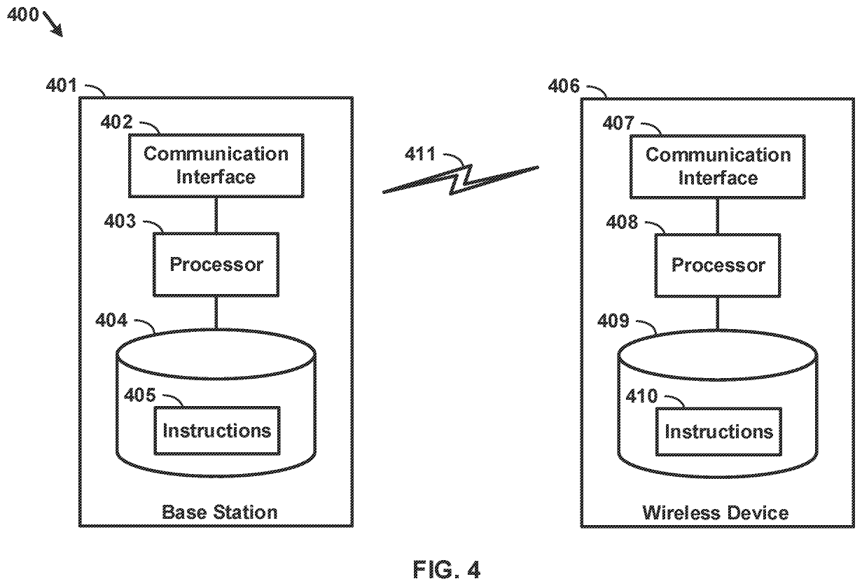

FIG. 4 is an example block diagram of a base station 401 and a wireless device 406, as per an aspect of an embodiment of the present disclosure. A communication network 400 may include at least one base station 401 and at least one wireless device 406. The base station 401 may include at least one communication interface 402, at least one processor 403, and at least one set of program code instructions 405 stored in non-transitory memory 404 and executable by the at least one processor 403. The wireless device 406 may include at least one communication interface 407, at least one processor 408, and at least one set of program code instructions 410 stored in non-transitory memory 409 and executable by the at least one processor 408. Communication interface 402 in base station 401 may be configured to engage in communication with communication interface 407 in wireless device 406 via a communication path that includes at least one wireless link 411. Wireless link 411 may be a bi-directional link. Communication interface 407 in wireless device 406 may also be configured to engage in a communication with communication interface 402 in base station 401. Base station 401 and wireless device 406 may be configured to send and receive data over wireless link 411 using multiple frequency carriers. According to aspects of an embodiments, transceiver(s) may be employed. A transceiver is a device that includes both a transmitter and receiver. Transceivers may be employed in devices such as wireless devices, base stations, relay nodes, and/or the like. Example embodiments for radio technology implemented in communication interface 402, 407 and wireless link 411 are illustrated are FIG. 1, FIG. 2, FIG. 3, FIG. 5, and associated text.

An interface may be a hardware interface, a firmware interface, a software interface, and/or a combination thereof. The hardware interface may include connectors, wires, electronic devices such as drivers, amplifiers, and/or the like. A software interface may include code stored in a memory device to implement protocol(s), protocol layers, communication drivers, device drivers, combinations thereof, and/or the like. A firmware interface may include a combination of embedded hardware and code stored in and/or in communication with a memory device to implement connections, electronic device operations, protocol(s), protocol layers, communication drivers, device drivers, hardware operations, combinations thereof, and/or the like.

The term configured may relate to the capacity of a device whether the device is in an operational or non-operational state. Configured may also refer to specific settings in a device that effect the operational characteristics of the device whether the device is in an operational or non-operational state. In other words, the hardware, software, firmware, registers, memory values, and/or the like may be “configured” within a device, whether the device is in an operational or nonoperational state, to provide the device with specific characteristics. Terms such as “a control message to cause in a device” may mean that a control message has parameters that may be used to configure specific characteristics in the device, whether the device is in an operational or non-operational state.

According to various aspects of an embodiment, an LTE network may include a multitude of base stations, providing a user plane PDCP/RLC/MAC/PHY and control plane (RRC) protocol terminations towards the wireless device. The base station(s) may be interconnected with other base station(s) (for example, interconnected employing an X2 interface). Base stations may also be connected employing, for example, an S1 interface to an EPC. For example, base stations may be interconnected to the MME employing the S1-MME interface and to the S-G) employing the S1-U interface. The S1 interface may support a many-to-many relation between MMEs/Serving Gateways and base stations. A base station may include many sectors for example: 1, 2, 3, 4, or 6 sectors. A base station may include many cells, for example, ranging from 1 to 50 cells or more. A cell may be categorized, for example, as a primary cell or secondary cell. At RRC connection establishment/re-establishment/handover, one serving cell may provide the NAS (non-access stratum) mobility information (e.g. TAI), and at RRC connection re-establishment/handover, one serving cell may provide the security input. This cell may be referred to as the Primary Cell (PCell). In the downlink, the carrier corresponding to the PCell may be the Downlink Primary Component Carrier (DL PCC), while in the uplink, the carrier corresponding to the PCell may be the Uplink Primary Component Carrier (UL PCC). Depending on wireless device capabilities, Secondary Cells (SCells) may be configured to form together with the PCell a set of serving cells. In the downlink, the carrier corresponding to an SCell may be a Downlink Secondary Component Carrier (DL SCC), while in the uplink, it may be an Uplink Secondary Component Carrier (UL SCC). An SCell may or may not have an uplink carrier.

A cell, comprising a downlink carrier and optionally an uplink carrier, may be assigned a physical cell ID and a cell index. A carrier (downlink or uplink) may belong to only one cell. The cell ID or Cell index may also identify the downlink carrier or uplink carrier of the cell (depending on the context it is used). In the specification, cell ID may be equally referred to a carrier ID, and cell index may be referred to carrier index. In implementation, the physical cell ID or cell index may be assigned to a cell. A cell ID may be determined using a synchronization signal transmitted on a downlink carrier. A cell index may be determined using RRC messages. For example, when the specification refers to a first physical cell ID for a first downlink carrier, the specification may mean the first physical cell ID is for a cell comprising the first downlink carrier. The same concept may apply, for example, to carrier activation. When the specification indicates that a first carrier is activated, the specification may also mean that the cell comprising the first carrier is activated.

Embodiments may be configured to operate as needed. The disclosed mechanism may be performed when certain criteria are met, for example, in a wireless device, a base station, a radio environment, a network, a combination of the above, and/or the like. Example criteria may be based, at least in part, on for example, traffic load, initial system set up, packet sizes, traffic characteristics, a combination of the above, and/or the like. When the one or more criteria are met, various example embodiments may be applied. Therefore, it may be possible to implement example embodiments that selectively implement disclosed protocols.

A base station may communicate with a mix of wireless devices. Wireless devices may support multiple technologies, and/or multiple releases of the same technology. Wireless devices may have some specific capability(ies) depending on its wireless device category and/or capability(ies). A base station may comprise multiple sectors. When this disclosure refers to a base station communicating with a plurality of wireless devices, this disclosure may refer to a subset of the total wireless devices in a coverage area. This disclosure may refer to, for example, a plurality of wireless devices of a given LTE release with a given capability and in a given sector of the base station. The plurality of wireless devices in this disclosure may refer to a selected plurality of wireless devices, and/or a subset of total wireless devices in a coverage area which perform according to disclosed methods, and/or the like. There may be a plurality of wireless devices in a coverage area that may not comply with the disclosed methods, for example, because those wireless devices perform based on older releases of LTE technology.

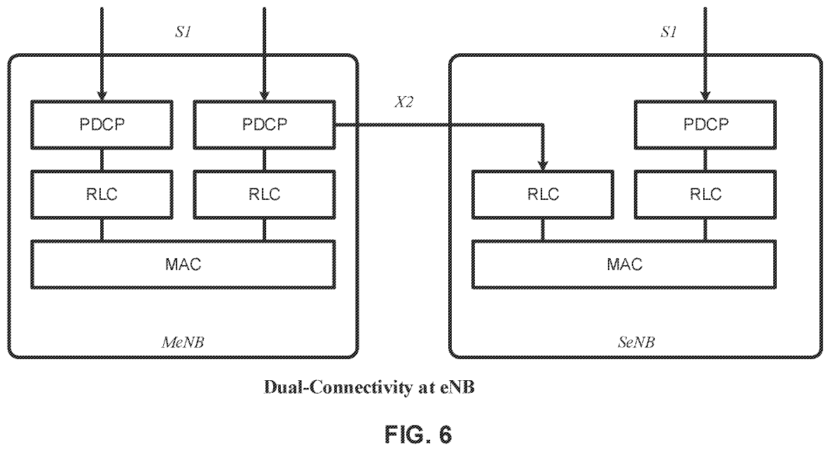

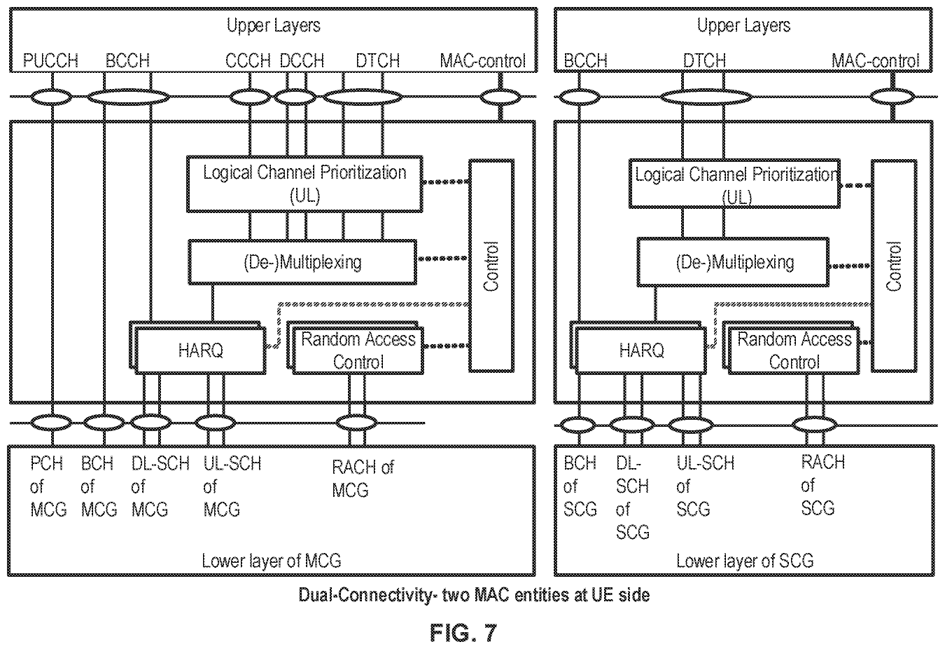

FIG. 6 and FIG. 7 are example diagrams for protocol structure with CA and DC as per an aspect of an embodiment of the present disclosure. E-UTRAN may support Dual Connectivity (DC) operation whereby a multiple RX/TX UE in RRC_CONNECTED may be configured to utilize radio resources provided by two schedulers located in two eNBs connected via a non-ideal backhaul over the X2 interface. eNBs involved in DC for a certain UE may assume two different roles: an eNB may either act as an MeNB or as an SeNB. In DC a UE may be connected to one MeNB and one SeNB. Mechanisms implemented in DC may be extended to cover more than two eNBs. FIG. 7 illustrates one example structure for the UE side MAC entities when a Master Cell Group (MCG) and a Secondary Cell Group (SCG) are configured, and it may not restrict implementation. Media Broadcast Multicast Service (MBMS) reception is not shown in this figure for simplicity.

In DC, the radio protocol architecture that a particular bearer uses may depend on how the bearer is setup. Three alternatives may exist, an MCG bearer, an SCG bearer and a split bearer as shown in FIG. 6. RRC may be located in MeNB and SRBs may be configured as a MCG bearer type and may use the radio resources of the MeNB. DC may also be described as having at least one bearer configured to use radio resources provided by the SeNB. DC may or may not be configured/implemented in example embodiments of the disclosure.

In the case of DC, the UE may be configured with two MAC entities: one MAC entity for MeNB, and one MAC entity for SeNB. In DC, the configured set of serving cells for a UE may comprise two subsets: the Master Cell Group (MCG) containing the serving cells of the MeNB, and the Secondary Cell Group (SCG) containing the serving cells of the SeNB. For a SCG, one or more of the following may be applied. At least one cell in the SCG may have a configured UL CC and one of them, named PSCell (or PCell of SCG, or sometimes called PCell), may be configured with PUCCH resources. When the SCG is configured, there may be at least one SCG bearer or one Split bearer. Upon detection of a physical layer problem or a random access problem on a PSCell, or the maximum number of RLC retransmissions has been reached associated with the SCG, or upon detection of an access problem on a PSCell during a SCG addition or a SCG change: a RRC connection re-establishment procedure may not be triggered, UL transmissions towards cells of the SCG may be stopped, and a MeNB may be informed by the UE of a SCG failure type. For split bearer, the DL data transfer over the MeNB may be maintained. The RLC AM bearer may be configured for the split bearer. Like a PCell, a PSCell may not be de-activated. A PSCell may be changed with a SCG change (for example, with a security key change and a RACH procedure), and/or neither a direct bearer type change between a Split bearer and a SCG bearer nor simultaneous configuration of a SCG and a Split bearer may be supported.

With respect to the interaction between a MeNB and a SeNB, one or more of the following principles may be applied. The MeNB may maintain the RRM measurement configuration of the UE and may, (for example, based on received measurement reports or traffic conditions or bearer types), decide to ask a SeNB to provide additional resources (serving cells) for a UE. Upon receiving a request from the MeNB, a SeNB may create a container that may result in the configuration of additional serving cells for the UE (or decide that it has no resource available to do so). For UE capability coordination, the MeNB may provide (part of) the AS configuration and the UE capabilities to the SeNB. The MeNB and the SeNB may exchange information about a UE configuration by employing RRC containers (inter-node messages) carried in X2 messages. The SeNB may initiate a reconfiguration of its existing serving cells (for example, a PUCCH towards the SeNB). The SeNB may decide which cell is the PSCell within the SCG. The MeNB may not change the content of the RRC configuration provided by the SeNB. In the case of a SCG addition and a SCG SCell addition, the MeNB may provide the latest measurement results for the SCG cell(s). Both a MeNB and a SeNB may know the SFN and subframe offset of each other by OAM, (for example, for the purpose of DRX alignment and identification of a measurement gap). In an example, when adding a new SCG SCell, dedicated RRC signaling may be used for sending required system information of the cell as for CA, except for the SFN acquired from a MIB of the PSCell of a SCG.

In an example, serving cells may be grouped in a TA group (TAG). Serving cells in one TAG may use the same timing reference. For a given TAG, user equipment (UE) may use at least one downlink carrier as a timing reference. For a given TAG, a UE may synchronize uplink subframe and frame transmission timing of uplink carriers belonging to the same TAG. In an example, serving cells having an uplink to which the same TA applies may correspond to serving cells hosted by the same receiver. A UE supporting multiple TAs may support two or more TA groups. One TA group may contain the PCell and may be called a primary TAG (pTAG). In a multiple TAG configuration, at least one TA group may not contain the PCell and may be called a secondary TAG (sTAG). In an example, carriers within the same TA group may use the same TA value and/or the same timing reference. When DC is configured, cells belonging to a cell group (MCG or SCG) may be grouped into multiple TAGs including a pTAG and one or more sTAGs.

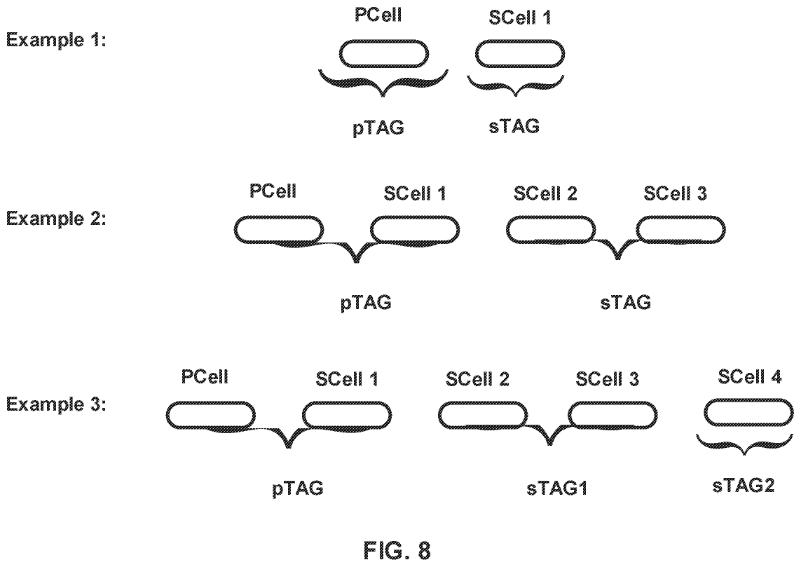

FIG. 8 shows example TAG configurations as per an aspect of an embodiment of the present disclosure. In Example 1, pTAG comprises a PCell, and an sTAG comprises SCell1. In Example 2, a pTAG comprises a PCell and SCell1, and an sTAG comprises SCell2 and SCell3. In Example 3, pTAG comprises PCell and SCell1, and an sTAG1 includes SCell2 and SCell3, and sTAG2 comprises SCell4. Up to four TAGs may be supported in a cell group (MCG or SCG) and other example TAG configurations may also be provided. In various examples in this disclosure, example mechanisms are described for a pTAG and an sTAG. Some of the example mechanisms may be applied to configurations with multiple sTAGs.

In an example, an eNB may initiate an RA procedure via a PDCCH order for an activated SCell. This PDCCH order may be sent on a scheduling cell of this SCell. When cross carrier scheduling is configured for a cell, the scheduling cell may be different than the cell that is employed for preamble transmission, and the PDCCH order may include an SCell index. At least a non-contention based RA procedure may be supported for SCell(s) assigned to sTAG(s).

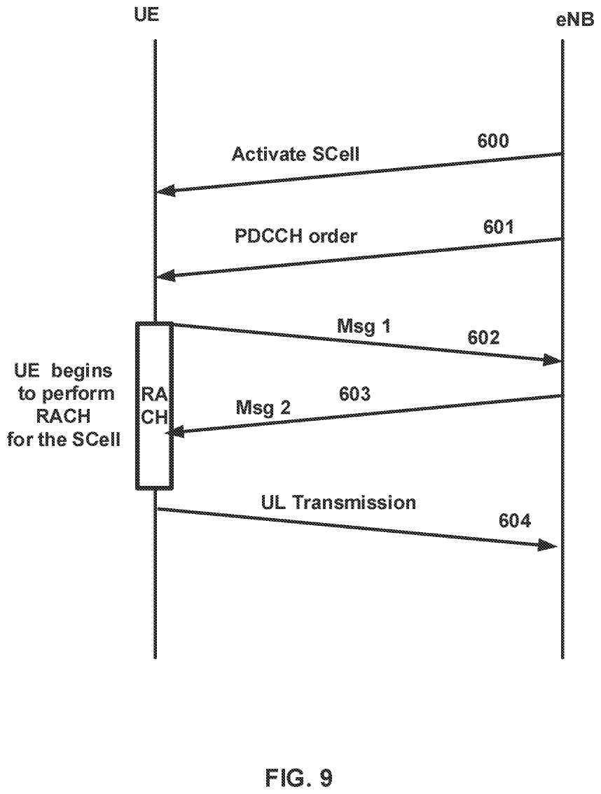

FIG. 9 is an example message flow in a random access process in a secondary TAG as per an aspect of an embodiment of the present disclosure. An eNB transmits an activation command 600 to activate an SCell. A preamble 602 (Msg1) may be sent by a UE in response to a PDCCH order 601 on an SCell belonging to an sTAG. In an example embodiment, preamble transmission for SCells may be controlled by the network using PDCCH format IA. Msg2 message 603 (RAR: random access response) in response to the preamble transmission on the SCell may be addressed to RA-RNTI in a PCell common search space (CSS). Uplink packets 604 may be transmitted on the SCell in which the preamble was transmitted.

According to an embodiment, initial timing alignment may be achieved through a random access procedure. This may involve a UE transmitting a random access preamble and an eNB responding with an initial TA command NTA (amount of timing advance) within a random access response window. The start of the random access preamble may be aligned with the start of a corresponding uplink subframe at the UE assuming NTA=0. The eNB may estimate the uplink timing from the random access preamble transmitted by the UE. The TA command may be derived by the eNB based on the estimation of the difference between the desired UL timing and the actual UL timing. The UE may determine the initial uplink transmission timing relative to the corresponding downlink of the sTAG on which the preamble is transmitted.

The mapping of a serving cell to a TAG may be configured by a serving eNB with RRC signaling. The mechanism for TAG configuration and reconfiguration may be based on RRC signaling. According to various aspects of an embodiment, when an eNB performs an SCell addition configuration, the related TAG configuration may be configured for the SCell. In an example embodiment, an eNB may modify the TAG configuration of an SCell by removing (releasing) the SCell and adding (configuring) a new SCell (with the same physical cell ID and frequency) with an updated TAG ID. The new SCell with the updated TAG ID may initially be inactive subsequent to being assigned the updated TAG ID. The eNB may activate the updated new SCell and start scheduling packets on the activated SCell. In an example implementation, it may not be possible to change the TAG associated with an SCell, but rather, the SCell may need to be removed and a new SCell may need to be added with another TAG. For example, if there is a need to move an SCell from an sTAG to a pTAG, at least one RRC message, (for example, at least one RRC reconfiguration message), may be send to the UE to reconfigure TAG configurations by releasing the SCell and then configuring the SCell as a part of the pTAG. When an SCell is added/configured without a TAG index, the SCell may be explicitly assigned to the pTAG. The PCell may not change its TA group and may be a member of the pTAG.

The purpose of an RRC connection reconfiguration procedure may be to modify an RRC connection, (for example, to establish, modify and/or release RBs, to perform handover, to setup, modify, and/or release measurements, to add, modify, and/or release SCells). If the received RRC Connection Reconfiguration message includes the sCellToReleaseList, the UE may perform an SCell release. If the received RRC Connection Reconfiguration message includes the sCellToAddModList, the UE may perform SCell additions or modification.

In LTE Release-10 and Release-11 CA, a PUCCH may only be transmitted on the PCell (PSCell) to an eNB. In LTE-Release 12 and earlier, a UE may transmit PUCCH information on one cell (PCell or PSCell) to a given eNB.

As the number of CA capable UEs and also the number of aggregated carriers increase, the number of PUCCHs and also the PUCCH payload size may increase. Accommodating the PUCCH transmissions on the PCell may lead to a high PUCCH load on the PCell. A PUCCH on an SCell may be introduced to offload the PUCCH resource from the PCell. More than one PUCCH may be configured for example, a PUCCH on a PCell and another PUCCH on an SCell. In the example embodiments, one, two or more cells may be configured with PUCCH resources for transmitting CSI/ACK/NACK to a base station. Cells may be grouped into multiple PUCCH groups, and one or more cell within a group may be configured with a PUCCH. In an example configuration, one SCell may belong to one PUCCH group. SCells with a configured PUCCH transmitted to a base station may be called a PUCCH SCell, and a cell group with a common PUCCH resource transmitted to the same base station may be called a PUCCH group.

In an example embodiment, a MAC entity may have a configurable timer timeAlignmentTimer per TAG. The timeAlignmentTimer may be used to control how long the MAC entity considers the Serving Cells belonging to the associated TAG to be uplink time aligned. The MAC entity may, when a Timing Advance Command MAC control element is received, apply the Timing Advance Command for the indicated TAG; start or restart the timeAlignmentTimer associated with the indicated TAG. The MAC entity may, when a Timing Advance Command is received in a Random Access Response message for a serving cell belonging to a TAG and/or if the Random Access Preamble was not selected by the MAC entity, apply the Timing Advance Command for this TAG and start or restart the timeAlignmentTimer associated with this TAG. Otherwise, if the timeAlignmentTimer associated with this TAG is not running, the Timing Advance Command for this TAG may be applied and the timeAlignmentTimer associated with this TAG started. When the contention resolution is considered not successful, a timeAlignmentTimer associated with this TAG may be stopped. Otherwise, the MAC entity may ignore the received Timing Advance Command.

In example embodiments, a timer is running once it is started, until it is stopped or until it expires; otherwise it may not be running. A timer can be started if it is not running or restarted if it is running. For example, a timer may be started or restarted from its initial value.

Example embodiments of the disclosure may enable operation of multi-carrier communications. Other example embodiments may comprise a non-transitory tangible computer readable media comprising instructions executable by one or more processors to cause operation of multi-carrier communications. Yet other example embodiments may comprise an article of manufacture that comprises a non-transitory tangible computer readable machine-accessible medium having instructions encoded thereon for enabling programmable hardware to cause a device (e.g. wireless communicator, UE, base station, etc.) to enable operation of multi-carrier communications. The device may include processors, memory, interfaces, and/or the like. Other example embodiments may comprise communication networks comprising devices such as base stations, wireless devices (or user equipment: UE), servers, switches, antennas, and/or the like.

The amount of data traffic carried over cellular networks is expected to increase for many years to come. The number of users/devices is increasing and each user/device accesses an increasing number and variety of services, e.g. video delivery, large files, images. This may require not only high capacity in the network, but also provisioning very high data rates to meet customers' expectations on interactivity and responsiveness. More spectrum may therefore be needed for cellular operators to meet the increasing demand. Considering user expectations of high data rates along with seamless mobility, it may be beneficial that more spectrum be made available for deploying macro cells as well as small cells for cellular systems.

Striving to meet the market demands, there has been increasing interest from operators in deploying some complementary access utilizing unlicensed spectrum to meet the traffic growth. This is exemplified by the large number of operator-deployed Wi-Fi networks and the 3GPP standardization of LTE/WLAN interworking solutions. This interest indicates that unlicensed spectrum, when present, may be an effective complement to licensed spectrum for cellular operators to help addressing the traffic explosion in some scenarios, such as hotspot areas. LAA may offer an alternative for operators to make use of unlicensed spectrum while managing one radio network, thus offering new possibilities for optimizing the network's efficiency.

In an example embodiment, Listen-before-talk (clear channel assessment) may be implemented for transmission in an LAA cell. In a listen-before-talk (LBT) procedure, equipment may apply a clear channel assessment (CCA) check before using the channel. For example, the CCA may utilize at least energy detection to determine the presence or absence of other signals on a channel in order to determine if a channel is occupied or clear, respectively. For example, European and Japanese regulations mandate the usage of LBT in the unlicensed bands. Apart from regulatory requirements, carrier sensing via LBT may be one way for fair sharing of the unlicensed spectrum.

In an example embodiment, discontinuous transmission on an unlicensed carrier with limited maximum transmission duration may be enabled. Some of these functions may be supported by one or more signals to be transmitted from the beginning of a discontinuous LAA downlink transmission. Channel reservation may be enabled by the transmission of signals, by an LAA node, after gaining channel access via a successful LBT operation, so that other nodes that receive the transmitted signal with energy above a certain threshold sense the channel to be occupied. Functions that may need to be supported by one or more signals for LAA operation with discontinuous downlink transmission may include one or more of the following: detection of the LAA downlink transmission (including cell identification) by UEs, time & frequency synchronization of UEs, and/or the like.

In an example embodiment, a DL LAA design may employ subframe boundary alignment according to LTE-A carrier aggregation timing relationships across serving cells aggregated by CA. This may not imply that the eNB transmissions can start only at the subframe boundary. LAA may support transmitting PDSCH when not all OFDM symbols are available for transmission in a subframe according to LBT. Delivery of necessary control information for the PDSCH may also be supported.

An LBT procedure may be employed for fair and friendly coexistence of LAA with other operators and technologies operating in an unlicensed spectrum. LBT procedures on a node attempting to transmit on a carrier in an unlicensed spectrum may require the node to perform a clear channel assessment to determine if the channel is free for use. An LBT procedure may involve at least energy detection to determine if the channel is being used. For example, regulatory requirements in some regions, for example, in Europe, may specify an energy detection threshold such that if a node receives energy greater than this threshold, the node assumes that the channel is not free. While nodes may follow such regulatory requirements, a node may optionally use a lower threshold for energy detection than that specified by regulatory requirements. In an example, LAA may employ a mechanism to adaptively change the energy detection threshold. For example, LAA may employ a mechanism to adaptively lower the energy detection threshold from an upper bound. Adaptation mechanism(s) may not preclude static or semi-static setting of the threshold. In an example a Category 4 LBT mechanism or other type of LBT mechanisms may be implemented.

Various example LBT mechanisms may be implemented. In an example, for some signals, in some implementation scenarios, in some situations, and/or in some frequencies, no LBT procedure may performed by the transmitting entity. In an example, Category 2 (for example, LBT without random back-off) may be implemented. The duration of time that the channel is sensed to be idle before the transmitting entity transmits may be deterministic. In an example, Category 3 (for example, LBT with random back-off with a contention window of fixed size) may be implemented. The LBT procedure may have the following procedure as one of its components. The transmitting entity may draw a random number N within a contention window. The size of the contention window may be specified by the minimum and maximum value of N. The size of the contention window may be fixed. The random number N may be employed in the LBT procedure to determine the duration of time that the channel is sensed to be idle before the transmitting entity transmits on the channel. In an example, Category 4 (for example, LBT with random back-off with a contention window of variable size) may be implemented. The transmitting entity may draw a random number N within a contention window. The size of the contention window may be specified by a minimum and maximum value of N. The transmitting entity may vary the size of the contention window when drawing the random number N. The random number N may be employed in the LBT procedure to determine the duration of time that the channel is sensed to be idle before the transmitting entity transmits on the channel.

LAA may employ uplink LBT at the UE. The UL LBT scheme may be different from the DL LBT scheme (for example, by using different LBT mechanisms or parameters), since the LAA UL may be based on scheduled access which affects a UE's channel contention opportunities. Other considerations motivating a different UL LBT scheme include, but are not limited to, multiplexing of multiple UEs in a single subframe.

In an example, a DL transmission burst may be a continuous transmission from a DL transmitting node with no transmission immediately before or after from the same node on the same CC. A UL transmission burst from a UE perspective may be a continuous transmission from a UE with no transmission immediately before or after from the same UE on the same CC. In an example, a UL transmission burst may be defined from a UE perspective. In an example, a UL transmission burst may be defined from an eNB perspective. In an example, in case of an eNB operating DL+UL LAA over the same unlicensed carrier, DL transmission burst(s) and UL transmission burst(s) on LAA may be scheduled in a TDM manner over the same unlicensed carrier. For example, an instant in time may be part of a DL transmission burst or an UL transmission burst.

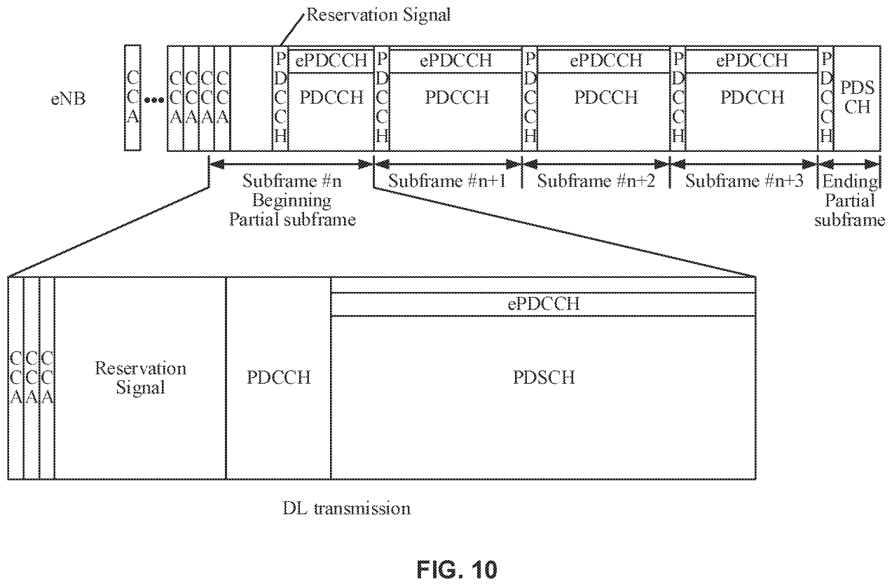

In an example embodiment, in an unlicensed cell, a downlink burst may be started in a subframe. When an eNB accesses the channel, the eNB may transmit for a duration of one or more subframes. The duration may depend on a maximum configured burst duration in an eNB, the data available for transmission, and/or eNB scheduling algorithm. FIG. 10 shows an example downlink burst in an unlicensed (e.g. licensed assisted access) cell. The maximum configured burst duration in the example embodiment may be configured in the eNB. An eNB may transmit the maximum configured burst duration to a UE employing an RRC configuration message.

The wireless device may receive from a base station at least one message (for example, an RRC) comprising configuration parameters of a plurality of cells. The plurality of cells may comprise at least one cell of a first type (e.g. license cell) and at least one cell of a second type (e.g. unlicensed cell, an LAA cell). The configuration parameters of a cell may, for example, comprise configuration parameters for physical channels, (for example, a ePDCCH, PDSCH, PUSCH, PUCCH and/or the like). The wireless device may determine transmission powers for one or more uplink channels. The wireless device may transmit uplink signals via at least one uplink channel based on the determined transmission powers.

In an example embodiment, LTE transmission time may include frames, and a frame may include many subframes. The size of various time domain fields in the time domain may be expressed as a number of time units Tₛ=1/(1500×2048) seconds. Downlink, uplink and sidelink transmissions may be organized into radio frames with T_{f}=307200×Tₛ=10 ms duration. In an example LTE implementation, at least three radio frame structures may be supported: Type 1, applicable to FDD, Type 2, applicable to TDD, Type 3, applicable to LAA secondary cell operation. LAA secondary cell operation applies to frame structure type 3.

Transmissions in multiple cells may be aggregated where one or more secondary cells may be used in addition to the primary cell. In case of multi-cell aggregation, different frame structures may be used in the different serving cells.

Frame structure type 1 may be applicable to both full duplex and half duplex FDD. A radio frame is T_{f}=30720·Tₛ=10 ms long and may comprise 20 slots of length Tₛₗₒₜ=15360·Tₛ=0.5 ms, numbered from 0 to 19. A subframe may include two consecutive slots where subframe i comprises of slots 2ᵢ and 2ᵢ₊₁.

For FDD, 10 subframes are available for downlink transmission and 10 subframes are available for uplink transmissions in a 10 ms interval. Uplink and downlink transmissions are separated in the frequency domain. In half-duplex FDD operation, the UE may not transmit and receive at the same time while there may not be such restrictions in full-duplex FDD.

Frame structure type 2 may be applicable to TDD. A radio frame of length T_{f}=307200·Tₛ=10 n may comprise of two half-frames of length 153600·Tₛ=5 ms. A half-frame may comprise five subframes of length 30720·Tₛ=5 ms. A subframe i may comprise two slots, 2ᵢ and 2ᵢ₊₁, of length Tₛₗₒₜ=15360·Tₛ=0.5 ms.

The uplink-downlink configuration in a cell may vary between frames and controls in which subframes uplink or downlink transmissions may take place in the current frame. The uplink-downlink configuration in the current frame is obtained via control signaling.

An example subframe in a radio frame, may be a downlink subframe reserved for downlink transmissions, may be an uplink subframe reserved for uplink transmissions or may be a special subframe with the three fields DwPTS, GP and UpPTS. The length of DwPTS and UpPTS are subject to the total length of DwPTS, GP and UpPTS being equal to 30720·Tₛ=1 ms.

Uplink-downlink configurations with both 5 ms and 10 ms downlink-to-uplink switch-point periodicity may be supported. In case of 5 ms downlink-to-uplink switch-point periodicity, the special subframe may exist in both half-frames. In case of 10 ms downlink-to-uplink switch-point periodicity, the special subframe may exist in the first half-frame.

Subframes 0 and 5 and DwPTS may be reserved for downlink transmission. UpPTS and the subframe immediately following the special subframe may be reserved for uplink transmission.

In an example, in case multiple cells are aggregated, the UE may assume that the guard period of the special subframe in the cells using frame structure Type 2 have an overlap of at least 1456·Tₛ.

In an example, in case multiple cells with different uplink-downlink configurations in the current radio frame are aggregated and the UE is not capable of simultaneous reception and transmission in the aggregated cells, the following constraints may apply. if the subframe in the primary cell is a downlink subframe, the UE may not transmit any signal or channel on a secondary cell in the same subframe. If the subframe in the primary cell is an uplink subframe, the UE may not be expected to receive any downlink transmissions on a secondary cell in the same subframe. If the subframe in the primary cell is a special subframe and the same subframe in a secondary cell is a downlink subframe, the UE may not be expected to receive PDSCH/EPDCCH/PMCH/PRS transmissions in the secondary cell in the same subframe, and the UE may not be expected to receive any other signals on the secondary cell in OFDM symbols that overlaps with the guard period or UpPTS in the primary cell.

Frame structure type 3 may be applicable to LAA secondary cell operation with normal cyclic prefix. A radio frame is T_{f}=307200·Tₛ=10 ms long and comprises of 20 slots of length Tₛₗₒₜ=15360·Tₛ=0.5 ms, numbered from 0 to 19. A subframe may comprise as two consecutive slots where subframe i comprises slots 2ᵢ and 2ᵢ₊₁.

The 10 subframes within a radio frame are available for downlink transmissions. Downlink transmissions occupy one or more consecutive subframes, starting anywhere within a subframe and ending with the last subframe either fully occupied or following one of the DwPTS durations. Subframes may be available for uplink transmission when LAA uplink is supported.

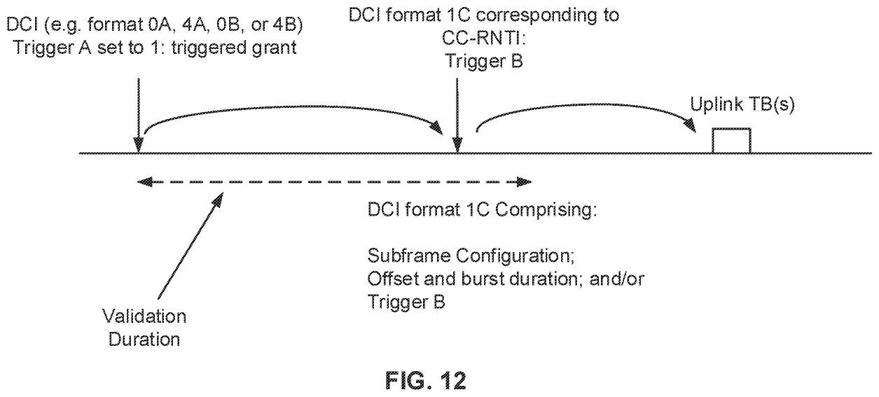

FIG. 12 shows an example 2-stage triggered grant with trigger A and trigger B. In an example embodiment, DCI 0A/4A/0B/4B may include a bit to indicate whether an UL grant is a triggered grant or not. If it is a triggered grant, the UE may transmit after receiving a trigger (e.g. one bit set to 1) in the PDCCH DCI scrambled with CC-RNTI in a subframe received after the subframe carrying the trigger. The timing between the 2nd trigger transmitted in subframe N and an earliest UL transmission may be a UE capability, if the earliest UL transmission is before subframe N+4 (e.g. UE capability signaling between transmission in subframe N+1 and N+2 and N+3). DCI 0A/4A/0B/4B may comprise one or more fields indicating resource block assignment, modulation and coding scheme, RV, HARQ information, transmit power control command, trigger A, and/or other physical layer parameters. The trigger may be received during a validation duration. The validation duration may be determined based on a field in the DCI including the uplink grant. The UE may monitor CC-RNTI for a trigger during the validation duration at least until the trigger is received.

DCI format 1C is used for example for LAA common information. The DCI format 1C in an LAA cell may comprise subframe configuration for an LAA cell-j bits (e.g., j=4) indicating a number of symbols. DCI format 1C may further comprise other information. DCI format 1C may further comprise, for example, k-bits (e.g. k=5) to indicate combinations of offset and burst duration. In an example, a code points may include (offset, duration) combinations as follows: combinations of {{1, 2, 3, 4, 6}, {1, 2, 3, 4, 5, 6}}, Reserved, no signaling of burst and offset. The format of the bits may be defined according to a pre-defined table. DCI format 1C may further comprise PUSCH trigger field (e.g. 1 bit) to indicate a trigger for a two-stage grant. For example, value 1 may indicate a trigger B and value 0 may indicate no trigger B. Reserved information bits may be added until the size is equal to that of format 1C used for very compact scheduling of one PDSCH code-word.

In an example, if a serving cell is an LAA Scell, the UE may receive PDCCH with DCI CRC scrambled by CC-RNTI on the LAA SCell. In an example, the DCI CRC scrambled by CC-RNTI may be transmitted in the common search space of an LAA cell. Example PDCCH procedures are described here.

In an example, a control region of a serving cell may comprise of a set of CCEs, numbered from 0 to N_{CCE,k}−1 according, where N_{CCE,k} may be the total number of CCEs in the control region of subframe k. The UE may monitor a set of PDCCH candidates on one or more activated serving cells as configured by higher layer signaling for control information, where monitoring implies attempting to decode the PDCCHs in the set according to monitored DCI formats. A BL/CE UE may not be required to monitor PDCCH.

In an example, the set of PDCCH candidates to monitor are defined in terms of search spaces, where a search space Sₖ^{(L)} at aggregation level L∈{1,2,4,8} is defined by a set of PDCCH candidates. For a serving cell on which PDCCH is monitored, the CCEs corresponding to PDCCH candidate m of the search space Sₖ^{(L)} are given by L{(Yₖ+m′) mod└N_{CCE,k}/L┘}+i, where Yₖ is defined below, i=0, . . . ,L−1. For the common search space m′=m. For the PDCCH UE specific search space, for the serving cell on which PDCCH is monitored, if the monitoring UE is configured with carrier indicator field then m′=m+M^{(L)}·n_{CI} where n_{CI} is the carrier indicator field value, else if the monitoring UE is not configured with carrier indicator field then m′=m, where m=0, . . . ,M^{(L)}−1, M^{(L)} is the number of PDCCH candidates to monitor in the given search space.

In an example, if a UE is configured with higher layer parameter cif-InSchedulingCell, the carrier indicator field value corresponds to cif-InSchedulingCell, otherwise, the carrier indicator field value is the same as ServCellIndex. The UE may monitor one common search space in a non-DRX subframe at aggregation levels 4 and 8 on the primary cell. A UE may monitor common search space on a cell to decode the PDCCHs necessary to receive MBMS on that cell when configured by higher layers.

In an example, if a UE is not configured for EPDCCH monitoring, and if the UE is not configured with a carrier indicator field, then the UE may monitor one PDCCH UE-specific search space at aggregation levels 1, 2, 4, 8 on an activated serving cell in every non-DRX subframe. If a UE is not configured for EPDCCH monitoring, and if the UE is configured with a carrier indicator field, then the UE may monitor one or more UE-specific search spaces at aggregation levels 1, 2, 4, 8 on one or more activated serving cells as configured by higher layer signaling in every non-DRX subframe.

In an example, if a UE is configured for EPDCCH monitoring on a serving cell, and if that serving cell is activated, and if the UE is not configured with a carrier indicator field, then the UE may monitor one PDCCH UE-specific search space at aggregation levels 1, 2, 4, 8 on that serving cell in non-DRX subframes where EPDCCH is not monitored on that serving cell. If a UE is configured for EPDCCH monitoring on a serving cell, and if that serving cell is activated, and if the UE is configured with a carrier indicator field, then the UE may monitor one or more PDCCH UE-specific search spaces at aggregation levels 1, 2, 4, 8 on that serving cell as configured by higher layer signaling in non-DRX subframes where EPDCCH is not monitored on that serving cell. The common and PDCCH UE-specific search spaces on the primary cell may overlap.

In an example, a UE configured with a carrier indicator field associated with monitoring PDCCH on serving cell c may monitor PDCCH configured with carrier indicator field and with CRC scrambled by C-RNTI in the PDCCH UE specific search space of serving cell c. A UE configured with the carrier indicator field associated with monitoring PDCCH on the primary cell may monitor PDCCH configured with carrier indicator field and with CRC scrambled by SPS C-RNTI in the PDCCH UE specific search space of the primary cell. The UE may monitor the common search space for PDCCH without carrier indicator field.

In an example, for the serving cell on which PDCCH is monitored, if the UE is not configured with a carrier indicator field, it may monitor the PDCCH UE specific search space for PDCCH without carrier indicator field, if the UE is configured with a carrier indicator field it may monitor the PDCCH UE specific search space for PDCCH with carrier indicator field. If the UE is not configured with a LAA Scell, the UE is not expected to monitor the PDCCH of a secondary cell if it is configured to monitor PDCCH with carrier indicator field corresponding to that secondary cell in another serving cell.

In an example, if the UE is configured with a LAA Scell, the UE is not expected to monitor the PDCCH UE specific space of the LAA SCell if it is configured to monitor PDCCH with carrier indicator field corresponding to that LAA Scell in another serving cell, where the UE is not expected to be configured to monitor PDCCH with carrier indicator field in an LAA Scell; and where the UE is not expected to be scheduled with PDSCH starting in the second slot in a subframe in an LAA Scell if the UE is configured to monitor PDCCH with carrier indicator field corresponding to that LAA Scell in another serving cell.

In an example, for the serving cell on which PDCCH is monitored, the UE may monitor PDCCH candidates at least for the same serving cell. A UE configured to monitor PDCCH candidates with CRC scrambled by C-RNTI or SPS C-RNTI with a common payload size and with the same first CCE index n_{CCE} but with different sets of DCI information fields in the common search space and/or PDCCH UE specific search space.

In an example, a UE configured to monitor PDCCH candidates in a given serving cell with a given DCI format size with CIF, and CRC scrambled by C-RNTI, where the PDCCH candidates may have one or more possible values of CIF for the given DCI format size, may assume that a PDCCH candidate with the given DCI format size may be transmitted in the given serving cell in any PDCCH UE specific search space corresponding to any of the possible values of CIF for the given DCI format size.

In an example, if a serving cell is an LAA Scell, the UE may receive PDCCH with DCI CRC scrambled by CC-RNTI on the LAA Scell. The DCI formats that the UE may monitor depend on the configured transmission mode of a serving cell.

Example subframe configuration for Frame Structure Type 3 are described here. If a UE detects PDCCH with DCI CRC scrambled by CC-RNTI in subframe n−1 or subframe n of a LAA Scell, the UE may assume the configuration of occupied OFDM symbols in subframe n of the LAA Scell according to the Subframe configuration for LAA field in the detected DCI in subframe n−1 or subframe n.

In an example, the Subframe configuration for LAA field indicates the configuration of occupied OFDM symbols (e.g., OFDM symbols used for transmission of downlink physical channels and/or physical signals) in current and/or next subframe according to a predefined table. If the configuration of occupied OFDM symbols for subframe n is indicated by the Subframe configuration for LAA field in both subframe n−1 and subframe n, the UE may assume that the same configuration of occupied OFDM symbols is indicated in both subframe n−1 and subframe n.

In an example, if a UE detects PDCCH with DCI CRC scrambled by CC-RNTI in subframe n, and the UE does not detect PDCCH with DCI CRC scrambled by CC-RNTI in subframe n−1, and if the number of occupied OFDM symbols for subframe n indicated by the Subframe configuration for LAA field in subframe n is less than 14, the UE is not required to receive any other physical channels in subframe n.

In an example, if a UE does not detect PDCCH with DCI CRC scrambled by CC-RNTI containing Subframe Configuration for LAA field set to other than ‘1110’ and ‘1111’ in subframe n and the UE does not detect PDCCH with DCI CRC scrambled by CC-RNTI containing Subframe Configuration for LAA field set to other than ‘1110’ and ‘1111’ in subframe n−1, the UE is not required to use subframe n for updating CSI measurement.

In an example, the UE may detect PDCCH with DCI CRC scrambled by CC-RNTI by monitoring the following PDCCH candidates according to DCI Format 1C: one PDCCH candidate at aggregation level L=4 with the CCEs corresponding to the PDCCH candidate given by CCEs numbered 0,1,2,3; one PDCCH candidate at aggregation level L=8 with the CCEs corresponding to the PDCCH candidate given by CCEs numbered 0,1,2,3,4,5,6,7.

In an example, if a serving cell is an LAA Scell, and if the higher layer parameter subframeStartPosition for the Scell indicates ‘s07’, and if the UE detects PDCCH/EPDCCH intended for the UE starting in the second slot of a subframe, the UE may assume that OFDM symbols in the first slot of the subframe are not occupied, and OFDM symbols in the second slot of the subframe are occupied. If subframe n is a subframe in which OFDM symbols in the first slot are not occupied, the UE may assume that the OFDM symbols are occupied in subframe n+1.

In an example embodiment, a field in DCI format 0A/4A/0B/4B for the triggered grant, e.g. 4-bit SF timing, may be reused to signal to the UE a subframe for transmission after reception of the trigger. When a UE receives a trigger in subframe N, the UE may be allowed to start transmission in subframe N+X+Y. 2 bits are reused to indicate X. X={0,1,2,3} may be indicated to the UE reusing two bits in the DCI. Y may be given by the UL burst offset in the C-PDCCH DCI scrambled by CC-RNTI (e.g. in the same subframe where the trigger is transmitted). The UE may receive signaling in the first DCI 0A/4A/0B/4B grant indicating the number of subframes after which the grant becomes invalid. The initial grant may become invalid if M ms after the initial grant, no valid trigger has been received, e.g. M={8,12,16,20}. In an example, a UE may follow the LBT type indicated by the UL grant.

In an example embodiment, C(common)-PDCCH may indicate a pair of values (UL burst duration, offset). UL burst duration may be a number of consecutive UL subframes belonging to the same channel occupancy. Offset may be the number of subframes to the start of indicated UL burst from the start of the subframe carrying the C-PDCCH.

In an example, DCI format 0A/0B/4A/4B may be used for the scheduling of PUSCH in an LAA SCell. In an example, the DCI format 0A/0B/4A/4B may comprise a PUSCH trigger A field comprising one bit. In an example, a value of zero for the PUSCH trigger A field may indicate non-triggered scheduling and a value of one for the PUSCH trigger A field may indicate triggered scheduling. In an example, for triggered scheduling the wireless device may receive a trigger B and/or further scheduling information in a subsequent common DCI. In an example, the DCI format 0A/0B/4A/4B may comprise a timing offset field comprising four bits. In an example, when the PUSCH trigger A is set to zero, the timing offset field may indicate an absolute timing offset for the PUSCH transmission. Otherwise, the first two bits of the timing offset field may indicate a timing offset relative to a second offset field indicated by the common DCI (e.g., indicated by an uplink duration and offset field of the common DCI). The last two bits of the timing offset field in the DCI format 0A/0B/4A/4B may indicate a time window within which the scheduling of PUSCH via triggered scheduling may be valid. The wireless device may monitor a common control channel for the common DCI during the time window, for example, until the wireless device receives the common DCI.

Example power control mechanisms for dual-connectivity is described below. Some aspects of the power control mechanisms described below are improved in example embodiments to enhance UE power consumption and uplink transmissions.

In an example, a UE may be configured with multiple cell groups. In an example, the UE may support synchronous dual connectivity but may not support asynchronous dual connectivity. In an example, the UE may support both synchronous dual connectivity and asynchronous dual connectivity. The higher layer parameter powerControlMode may indicate dual connectivity power control mode 1 and the maximum uplink timing difference between transmitted signals to different serving cells including serving cells belonging to different CGs may be equal to or less than the minimum requirement for maximum transmission timing difference for synchronous dual connectivity.

In an example, the UE may use the Dual Connectivity power control mode 1 procedures. If a PRACH transmission of the UE on the Pcell starting in subframe i1 of MCG overlaps in time domain with another PRACH transmission of the UE starting in subframe i2 of SCG, and if subframe i1 and subframe i2 overlap in time with more than one symbol, and if the total power of both the PRACH transmissions would exceed \hat{P}_{CMAX}(i1,i2), the UE may transmit the PRACH on the Pcell using the preamble transmission power P_{PRACH}. The UE may drop or adjust the power of the PRACH transmission in subframe i2 of SCG such that the total power does not exceed \hat{P}_{CMAX}(i1,i2), where \hat{P}_{CMAX} (i1,i2) is the linear value configured transmitted power for Dual Connectivity for the subframe pair (i1,i2). If the UE drops the PRACH transmission, it sends power ramping suspension indicator to the higher layers. If the UE adjusts the power of PRACH transmission, it may send power ramping suspension indicator to the higher layers.

In an example, a UE may be configured with multiple cell groups. The UE may support both synchronous dual connectivity and asynchronous dual connectivity. The higher layer parameter powerControlMode may not indicate dual connectivity power control mode 1 and the UE may use the Dual Connectivity power control mode 2 procedures. If a PRACH transmission on the Pcell in subframe i1 of MCG overlaps in time another PRACH transmission in subframe i2 of SCG, and if the time difference between the start of the two PRACH transmissions is less than 30720·Tₛ, and if the transmission timing of the PRACH on the Pcell is such that the UE is ready to transmit the PRACH on Pcell at least one subframe before subframe i1 of MCG, and if the total power of both the PRACH transmissions exceeds \hat{P}_{CMAX}(i1,i2), the UE may transmit the PRACH on the Pcell using the preamble transmission power PAM. The UE may drop or adjust the power of the PRACH transmission in subframe i2 of SCG such that the total power does not exceed \hat{P}_{CMAX}(i1,i2), where \hat{P}_{CMAX}(i1,i2) is the linear value configured transmitted power for Dual Connectivity for the subframe pair (i1,i2). If the UE drops the PRACH transmissions, it may send power ramping suspension indicator to the higher layers. If the UE adjusts the power of PRACH transmission, it may send power ramping suspension indicator to the higher layers.

In an example, the UE PUSCH/PUCCH transmission(s) in subframe i1 of CG1 may overlap in time with PUSCH/PUCCH transmission(s) in more than one symbol of subframe i2 of CG2. In an example, at least the last symbol the UE PUSCH/PUCCH transmission(s) in subframe i1 of CG1 may overlap in time with SRS transmission(s) of subframe i2. The UE may have a PUCCH/PUSCH transmission with UCI including HARQ-ACK/SR in subframe i1 of CG1. In an example, if the UE has a PUCCH transmission with UCI including HARQ-ACK/SR in subframe i1 of CG1 and if \hat{P}_{PUCCH_CG1}(i1) would exceed S1(i1), the UE may scale \hat{P}_{PUCCH_CG1}(i1) such that the condition α1(i1)·\hat{P}_{PUCCH_CG1}(i1)=max{0,S1(i1)} is satisfied where 0≤α1(i1)≤1 and \hat{P}′_{PUCCH_CG1}(i1)=α1(i1)·\hat{P}_{PUCCH_CG1}(i1). If \hat{P}_{PUCH_CG1}(i1) would not exceed S1(i1), \hat{P}′_{PUCCH_CG1}(i1)=\hat{P}_{PUCH_CG1}(i1). If the UE has PUSCH transmission with UCI including HARQ-ACK in subframe i1 of serving cell c₁∈CG1, and if \hat{P}_{PUSCH,c1}(i1) would exceed S1(i1), the UE may scale \hat{P}_{PUSCH,c1}(i1) such that the condition α1(i1)·\hat{P}_{PUSCH,c1}(i1)=max{0,S1(i1)} is satisfied where 0≤α1(i1)≤1 and \hat{P}′_{PUSCH,c1}(i1)=α1(i1)·\hat{P}_{PUSCH,c1}(i1). If \hat{P}_{PUSCH,c1}(i1) would not exceed S1(i1), \hat{P}′_{PUSCH,c1}(i1)=\hat{P}_{PUSCH,c1}(i1). S1(i1) may be determined as

$$S 1 ( i 1 ) = {\hat{P}}_{CMAX} ( i 1 , i 2 ) - {\hat{P}}_{u 1} ( i 1 ) - {\hat{P}}_{q 1} ( i 2 ) - min \{ \begin{matrix}max \{ \begin{matrix}0 , \\ {\hat{P}}_{CMAX} ( i 1 , i 2 ) \cdot \frac{{γ}_{CG 2}}{100} - {\hat{P}}_{q 1} ( i 2 )\end{matrix} \} , \\ {\hat{P}}_{q 1}^{′} ( i 2 )\end{matrix} \} ;$$

where \hat{P}ᵤ₁(i1)=\hat{P}_{PRACH_CG1}(i1).

In an example, the cell groups in a dual connectivity scenario (e.g., master cell group (MCG) and secondary cell group (SCG)) may be or may not be synchronized, e.g., their timing may or may not be aligned. The cells within a cell group (e.g., cells or MCG or cells of SCG) may be synchronized or substantially synchronized (e.g., synchronized within a few micro seconds difference in timing). This may result in two cases: synchronous dual connectivity, where subframe boundaries of the two cell groups may be aligned at the UE (e.g., substantially synchronous with a timing difference less than a threshold, for example about 35 us); or asynchronous dual connectivity, where subframe boundaries of the two cell groups may have an arbitrary timing relation at the UE (e.g., up to 0.5 ms).

In an example embodiment, the UE may indicate to the eNB using a capability message whether it can support synchronous dual connectivity and cannot support asynchronous dual connectivity or whether it can support both synchronous and asynchronous dual connectivity. In an example, the information element asynchronous in the capability message may indicate whether a UE supports asynchronous dual connectivity.

In an example, for a given cell group, changes in transmission power may occur at the subframe boundaries and the receiver (e.g., eNB) may assume that the transmission power remains constant across a subframe.

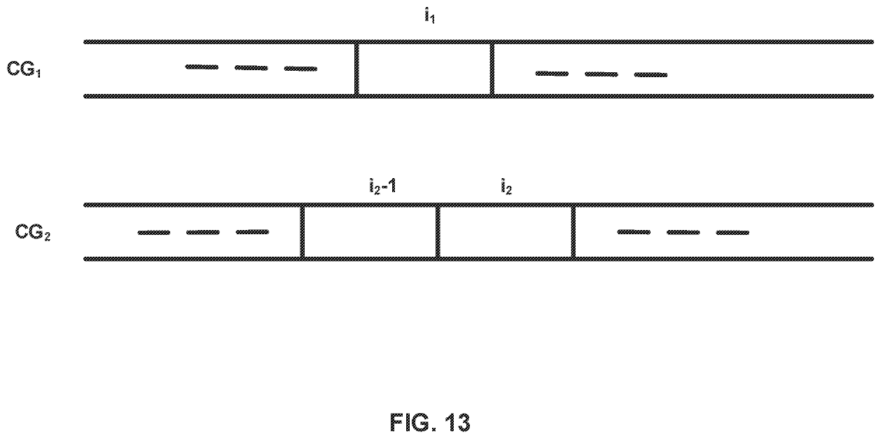

In an example, in synchronous dual connectivity, the subframe boundaries may be substantially aligned across the cell groups (e.g., cell group 1 (CG₁) and cell group 2 (CG₂)), for example, with a timing difference less than a threshold, for example about 35 us. In an example, in asynchronous dual connectivity, the subframe boundaries may not be aligned across the cell groups (e.g., cell group 1 (CG₁) and cell group 2 (CG₂)). In an example, the timing difference between CG₁ and CG₂ may be up to 0.5 ms. When setting the transmission power for a subframe in the CG₁ (for example subframe i1 in FIG. 13), the UE may know the activity (e.g., the signals and/or channels to be transmitted and their calculated transmission power) in the former overlapping subframe in the CG₂ (for example subframe i₂−1 in FIG. 13) and the UE may use this knowledge to calculate and/or scale the transmission power for the different channels and/or signals in subframe i1. In an example, when setting the transmission power of signals and/or channels in subframe i1 of CG₁, UE may not know the activity (e.g., the signals and/or channels to be transmitted and their calculated transmission power) in an overlapping subframe in CG₂ (for example subframe i2 in FIG. 13).

In an example, the scheduling decisions by the master eNB (MeNB) and secondary eNB (SeNB) may not be coordinated and the uplink grants transmitted to the UE by the MeNB and the SeNB may result in situations that the calculated power for transmissions to MeNB and SeNB may exceed the maximum configured UE transmission power (e.g., P_{CMAX}), resulting in the UE to be power limited. In an example, the UE may perform transmission power scaling using a power scaling rule in case of power limitation.

In an example, the UE may use power control mode 1 or power control mode 2 for dual connectivity power control. The eNB may indicate what power control mode to use with RRC signaling. In an example, the RRC parameter powerControlMode may indicate the power control mode to be used by the UE in dual connectivity. In an example, the UE may use the power control mode 1 if the UE supports synchronous dual connectivity and the UE does not support the asynchronous dual connectivity or the UE supports both synchronous and asynchronous dual connectivity and the eNB indicates to the UE through RRC configuration parameter powerControlMode to use the power control mode 1. In an example, the UE may use power control mode 2 if the UE supports both synchronous and asynchronous dual connectivity and the eNB indicates to the UE through RRC configuration parameter powerControlMode to use the power control mode 2.

In an example, in asynchronous dual connectivity with power control mode 2, subframe i₁ of CG₁ may overlap with two subframes of CG₂ (e.g., subframes i₂−1 and i₂, see for example FIG. 13) and the transmission power in subframe i₁ of CG₁ may depend on subframes i₂−1 and i₂ of CG₂. In an example, after a UE receives one or more grant for transmission on one or more cells of CG₁ on subframe i₁ (e.g., four subframes before subframe i₁) and when the UE calculates power levels of signals and/or channels to be transmitted on subframe i₁, the UE may not have processed the grant(s) for cells of the CG₂ that schedule transmission in one or more cells of CG₂ in subframe i₂ (which, for example, may have arrived four subframes before subframe i₂) and/or may not have calculated the power for signals and/or channels to be transmitted in subframe i₂ of the CG₂. The UE may not know how much power is needed for transmissions in subframe i₂ of CG₂ when the power levels of signals and/or channels to be transmitted on subframe i₁ of CG₁ is calculated. In an example, the UE may know the transmission power level of PRACH in subframe i₂ of CG₂ when the UE calculates the transmission power levels of signals and channels in subframe i₁ of CG₁ if the UE transmits a PRACH in subframe i₂ of CG₂.

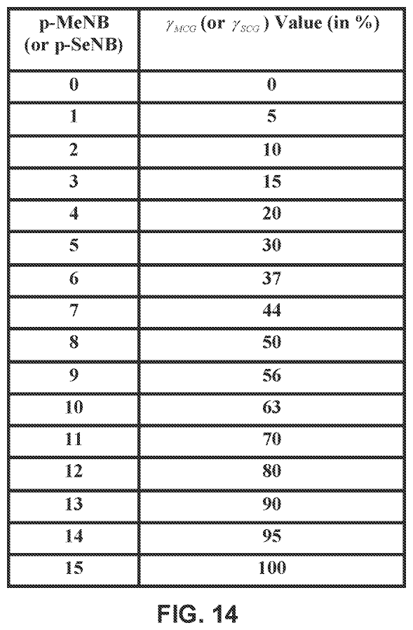

In an example, eNB may configure the parameters p-MeNB and/or p-SeNB using RRC configuration. In an example, p-MeNB and p-SeNB may take the values {0, 1, 2, . . . , 15}. In an example, eNB may configure the parameters p-MeNB and/or p-SeNB for the UE using RRC configuration. The parameters p-MeNB and p-SeNB may be mapped to γ_{MCG} and γ_{SCG}, respectively, using the table below. An example of p-MeNB and p-SeNB configuration parameters is shown in FIG. 14. In an example, γ_{MCG} and γ_{SCG} may be used by the UE for determining power allocation for dual connectivity.

In an example, in asynchronous dual connectivity with power control mode 2, if subframe i₁ of CGᵢ overlaps with subframes i₂−1 and i₂ of CG₂ with subframe i₂−1 starting earlier than subframe iₜ(see for example FIG. 13), and the UE has transmission(s) in subframe i₁ of CGᵢ, the UE may not be allowed to transmit more power than γ_{CG1} (e.g., γ_{MCG} if CG₁ is MCG and γ_{SCG} if CG₁ is SCG) percent of maximum configured UE transmission power at subframe i₁ of CG₁ unless the UE transmits PRACH at subframe i₁ of CGᵢ in which case the UE transmission power may be allowed to exceed γ_{CG1} percent of maximum configured transmission power. In an example, the UE transmission power in subframe i₂−1 of CG₂ (e.g., transmission power of PUSCH, PUCCH, SRS and PRACH in subframe i₂−1 of CG₂) and the UE transmission of PRACH in subframe i₂ of CG₂ and the UE transmission of PRACH in subframe i₁ of CGᵢ may have priority over the other transmissions (e.g., PUSCH, PUCCH and SRS) of UE in subframe i₁ of CGᵢ.

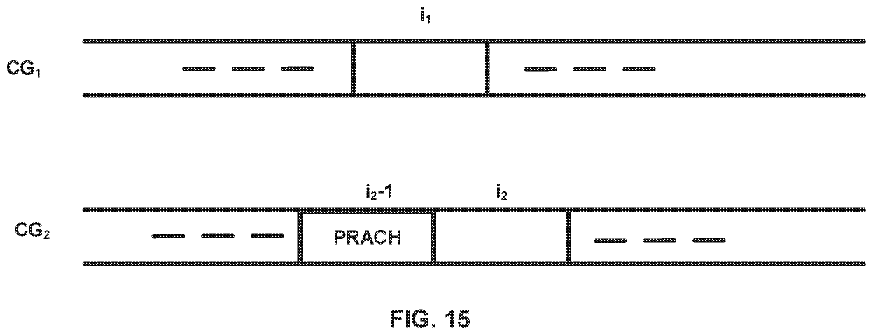

In an example, in synchronous dual connectivity with power control mode 1 or asynchronous dual connectivity with power control mode 2, there may be situations where the UE power may be allocated to transmissions on one cell group and no power may be left for the other cell group. In an example in asynchronous dual connectivity, PRACH may be transmitted in a cell of CG₂ on subframe i₂−1 that may overlap with subframe i₁ in CGᵢ (see for example FIG. 15) and UE may allocate the power for transmission of PRACH (e.g., when UE is in the cell edge). In such case, no power may be left for transmissions on CGᵢ in subframe iₜ of CG₁. In an example in synchronous dual connectivity, PRACH may be transmitted on a cell of CGᵢ on one or more subframes and may overlap with transmissions (e.g., PUSCH, PUCCH, SRS, etc.) at a subframe on one or more cell of CG₂. The UE may allocate the power to the PRACH transmission (e.g., when the UE is in the cell edge) and no power may be left for transmission at the subframe on the one or more cell of CG₂.

In an example, a preamble index, a target preamble received power (e.g., PREAMBLE_RECEIVED_TARGET_POWER), a corresponding RA-RNTI and a PRACH resource may be indicated by higher layers as part of the request. A preamble transmission power PPRACH may be determined as P_{PRACH}=min{P_{CMAC,c}(i), PREAMBLE_RECEIVED_TARGET_POWER+PL_{c}}_[dBm], where P_{CMAX,c}(i) may be the configured UE transmit power for subframe i of serving cell c and PL_{c} may be the downlink path loss estimate measured by the UE for serving cell c.

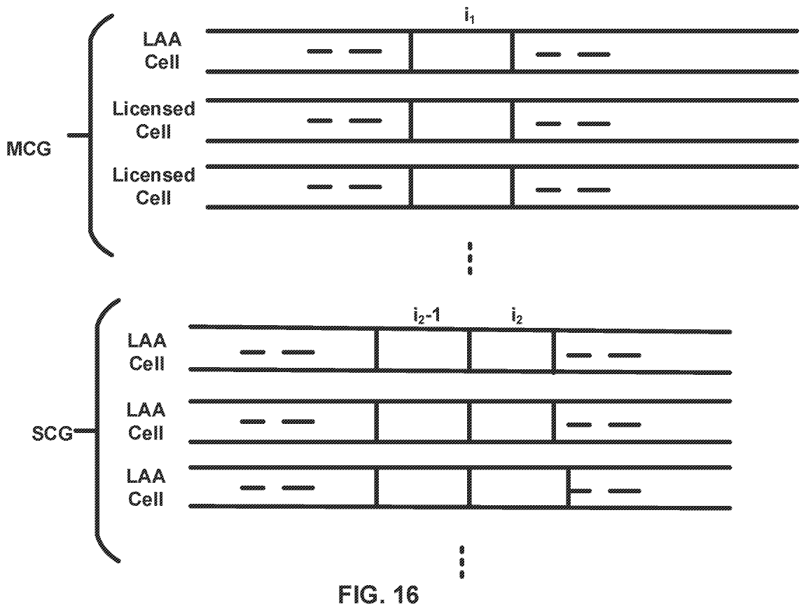

In an example, SCG may comprise one or more unlicensed LAA cell. In an example, the SCG may only comprise of LAA cells. In an example, the SCG may comprise both licensed cells and LAA cells. In an example, MCG may comprise one or more licensed cells. In an example, the MCG may only comprise licensed cells. In an example, the MCG may comprise both licensed and LAA cells. An example is shown in FIG. 16.

Some of the example embodiments may be implemented in carrier aggregation of a plurality of cells comprising one or more LAA cells (with no dual connectivity configuration). Some of the example embodiments may be implemented in carrier aggregation of a plurality of cells comprising one or more LAA cells (with dual connectivity configuration).

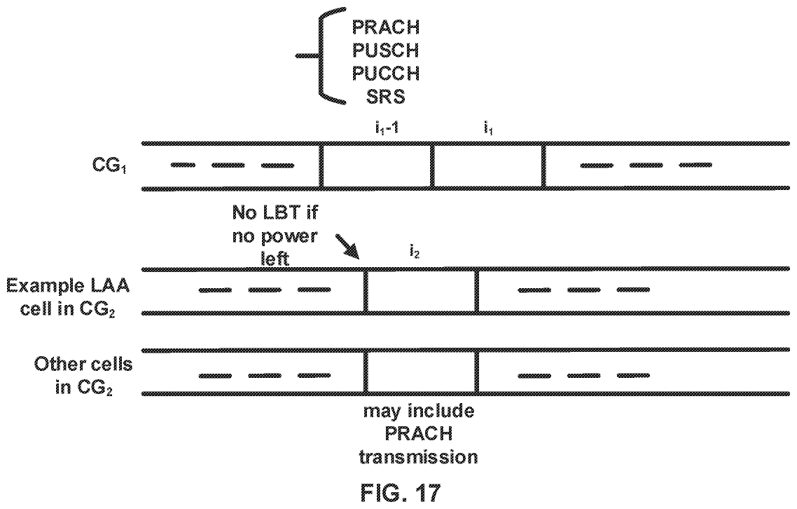

In an example embodiment, in asynchronous dual connectivity comprising cell groups 1 and 2 (e.g., CG₁ and CG₂), CG₂ may comprise one or more LAA cells. In an example, the UE may receive one or more grants scheduling the UE for transmission on one or more cells of CG₁ at subframe i₁−1. The UE may transmit a signal (e.g. PRACH) on a cell of CG₁ at subframe i₁−1. The UE may transmit a signal (e.g. PRACH) on a cell of CG₂ at subframe i₂. The UE may receive one or more grants scheduling the UE for transmission on one or more cells of CG₂ at subframe i₂ where subframe i₂ of CG₂ starts later than subframe i₁ of CG₁ (See for example FIG. 17). In an example, the one or more cells of CG₂ with grant for transmission on subframe i₂ comprises one or more LAA cells (for example see FIG. 17 where an example LAA cell of CG₂ is shown). In an example, the UE may allocate the maximum configured transmission power (e.g., P_{CMAX}) for transmissions in CG₁ (e.g., PUSCH, PUCCH, SRS, PRACH on one or more cells of CG₁) at subframe i₁−1 and no power may be left for transmission on the cells of CG₂ scheduled for transmission on subframe i₂. In an example, the UE may allocate the maximum configured transmission power for transmissions in CG₁ (e.g., PUSCH, PUCCH, SRS, PRACH on one or more cells of CG₁) at subframe i₁−1 and/or PRACH and/or PUCCH and/or PUSCH with UCI transmissions on a cell within CG₂ at subframe i₂ and no power may be left for other transmission on the cells of CG₂ scheduled for transmission on subframe i₂.

In an example embodiment, if a UE receives grant and is scheduled for transmission on subframe i₂ on a LAA cell of the CG₂ and no power is left for the UE for transmission on the LAA cell due to transmissions on subframe i₁−1 of CG₁ and/or other transmissions on cells of CG₂, the UE may ignore the grant scheduling the LAA cell on subframe i₂ and may not perform LBT for transmission on the LAA cell on subframe i₂ (See for example FIG. 17). In an example, if UE is expected to transmit a signal or channel (e.g., periodic SRS or PUCCH or other signals) on subframe i₂ on a LAA cell of the CG₂ and no power is left for the UE for transmission on the LAA cell due to transmissions on subframe i₁−1 of CG₁ and/or other transmissions (e.g., PRACH, PUCCH, etc.) on a cell within CG₂, the UE may the drop signal or channel and may not perform LBT.

In an example, when the physical layer ignores a grant for transmission (e.g., due to lack of power), the physical layer may or may not indicate to the MAC layer that the grant is ignored in the physical layer and/or the transmission is dropped. The MAC layer may create the MAC PDU and provide MAC PDU and HARQ information to the HARQ process.

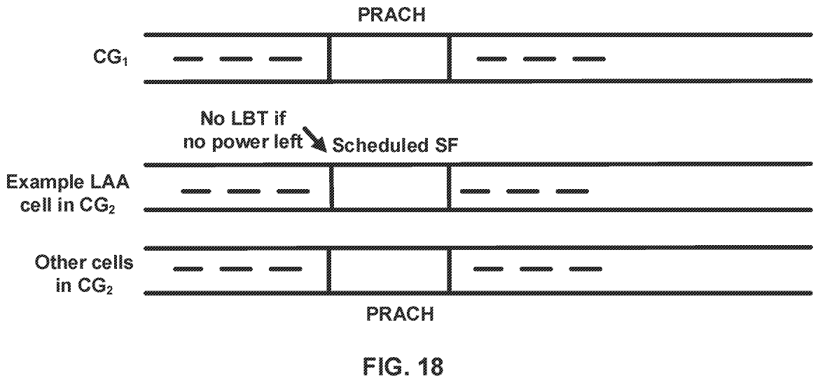

In an example embodiment, in synchronous dual connectivity comprising cell groups 1 and 2 (e.g., CG₁ and CG₂), CG₂ may comprising one or more LAA cells. The UE may receive one or more grants scheduling the UE for transmission on one or more cells of CG₂ at a subframe. In an example, the one or more cells of CG₂ with grant for transmission on the subframe may include one or more LAA cells. In an example, the UE may transmit PRACH on a cell of CG₁ and/or a cell of CG₂ at the subframe. In an example, the UE may allocate the maximum configured transmission power (e.g., P_{CMAX}) for transmission of PRACH in CG₁ or transmission of PRACH in CG₂ or transmission of PRACH in CG₁ and CG₂. In an example embodiment, if a UE receives grant and is scheduled for transmission on the subframe on a LAA cell of the CG₂ and no power is left for the UE for transmission on the LAA cell due to transmission(s) of PRACH on a cell of CG₁ and/or a cell of CG₂, the UE may ignore the grant scheduling the LAA cell on the subframe and may not perform LBT for transmission on the LAA cell on the subframe (See for example FIG. 18). In an example, if UE is expected to transmit a signal or channel (e.g., periodic SRS and/or PUCCH and/or other signals) on subframe i₂ on a LAA cell of the CG₂ and no power is left for the UE for transmission on the LAA cell due to transmissions on subframe i₁−1 of CG₁ and/or PRACH transmission on a cell within CG₂, the UE may the drop signal or channel and may not perform LBT.

An example embodiment may be implemented for uplink power control of carrier aggregation when dual connectivity is configured or not configured. For example, when UE does not have enough power to transmit a signal (e.g. PRACH, PUCCH, SRS, and/or PUSCH) on an LAA cell, the UE may not perform LBT for transmission of the signal. This may reduce UE processing requirements and reduce the battery power consumption. In an example, the transmission power for PRACH and/or PUCCH may exceed the UE maximum transmit power, and the UE may have no power to transmit SRS and/or PUSCH on an LAA cell. The UE may not perform LBT for transmission of the signal on the LAA cell in the subframe.

In an example embodiment, in asynchronous dual connectivity with SCG comprising one or more LAA cells, a PRACH transmission on the PCell in subframe i₁ of MCG may overlap in time another PRACH transmission in a LAA cell of SCG in subframe i₂ of SCG. In an example, the time difference between the start of the two PRACH transmissions may be less than 30720 Tₛ. The transmission timing of the PRACH on the PCell may be such that the UE may be ready to transmit the PRACH on PCell at least one subframe before subframe i₁ of MCG. In an example, the total power of both the PRACH transmissions may exceed \hat{P}_{CMAX}(i1,i2). The UE may transmit the PRACH on the PCell using the calculated preamble transmission power P_{PRACH}. The UE may drop or adjust the power of the PRACH transmission in the LAA cell of SCG in subframe i₂ of SCG such that the total power does not exceed \hat{P}_{CMAX}(11,12). The \hat{P}_{CMAX}(i1,i2) may be the linear value configured transmitted power for Dual Connectivity for the subframe pair (i1,i2) In an example embodiment, if the UE drops the PRACH transmissions on the LAA cell of the SCG, the UE may not perform LBT and may send power ramping suspension indicator to the higher layers. In an example, if the UE adjusts the power of PRACH transmission, the UE may perform LBT before preamble transmission and the UE may or may not send power ramping suspension indicator to the higher layers.

In an example embodiment, in synchronous dual connectivity with SCG comprising one or more LAA cells, a PRACH transmission of the UE on the PCell starting in subframe i₁ of MCG may overlap in time domain with another PRACH transmission of the UE starting in subframe i₂ of SCG. In an example, subframe i₁ and subframe i₂ may overlap in time with more than one symbol. In an example, if the total power of both the PRACH transmissions would exceed \hat{P}_{CMAX}(i1,i2), the UE may transmit the PRACH on the PCell using the calculated preamble transmission power P_{PRACH}. The UE may drop or adjust the power of the PRACH transmission in subframe i₂ of SCG such that the total power does not exceed \hat{P}_{CMAX}(i1,i2). The \hat{P}_{CMAX}(i1,i2) may be the linear value configured transmitted power for Dual Connectivity for the subframe pair (i1,i2) In an example, if the UE drops the PRACH transmission, the UE may not perform LBT and may send power ramping suspension indicator to the higher layers. If the UE adjusts the power of PRACH transmission, the UE may perform LBT and may or may not send power ramping suspension indicator to the higher layers.

In a carrier aggregation scenario of one or more cells comprising one or more LAA cells, the wireless device may assume that the LBT for the one or more LAA cells indicate clear channel when the wireless device calculates the transmission power or applies the power control scaling rules for the one or more cells in a scenario where the UE is power limited. This assumption may lead to a conservative power scaling and allocating a small amount of power for a channel or signal even if the wireless device does not transmit on an LAA cell due to unsuccessful LBT (e.g., LBT indicating busy channel) and the wireless device has enough power to increase the power level of the signal or channel. In asynchronous dual connectivity, the timing difference between two cell groups may be large (e.g., up to 0.5 ms). There may be enough time for physical layer processing of the scale factors if LBT on one or more LAA cells in a cell group indicates busy or clear channel. Example embodiments enhance the power scaling process in dual connectivity wherein a cell group comprises one or more LAA cells.

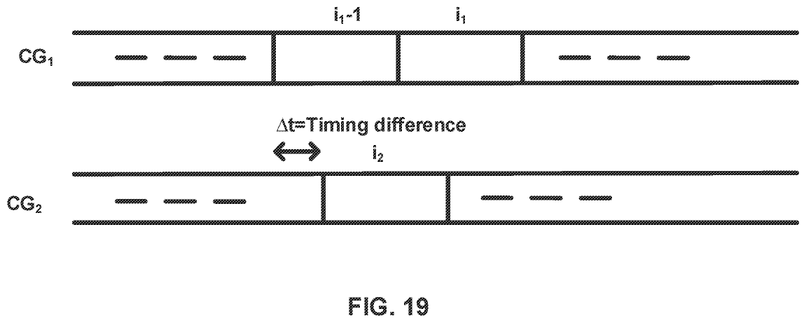

In an example embodiment, in asynchronous dual connectivity comprising cell groups 1 and 2 (e.g., CG₁ and CG₂), CG₁ may comprise one or more LAA cells. In an example, the UE may receive one or more grants scheduling the UE for transmission on one or more cells of CG₁ at subframe i₁−1 and the UE may receive one or more grants scheduling the UE for transmission on one or more cells of CG₂ at subframe i₂. In an example, the one or more cells of CG₁ that are scheduled to transmit at subframe i₁−1 may comprise one or more LAA cells. In an example, the timing of CG₁ and CG₂ are such that subframe i₁−1 starts earlier than subframe i₂ (See for example FIG. 19).

In an example embodiment, the UE may consider the LBT success or failure on the LAA cells in CG₁ on which transmission is attempted in subframe i₁−1 in order to apply the power scaling rules for transmissions on the set of carriers belonging to CG₂ that are scheduled to transmit at subframe i₂. In an example, the set of cells in CG₂ that are scheduled for transmission in subframe i₂ may include LAA cells. The UE may not consider success or failure of LBT for the LAA cells in CG₂ that are scheduled to transmit in subframe i₂ in its power scaling rules for transmissions on subframe i₂.

In an example embodiment, the UE may consider the LBT success or failure on the LAA cells in CG₁ on which transmission is attempted in subframe i₁−1 in order to apply the power scaling rules for transmissions on the set of carriers belonging to CG₂ that are scheduled to transmit in subframe i₂ if the timing difference of CG₁ and CG₂ (e.g., the difference between starting times of subframes i₁−1 and i₂, e.g., Δt in FIG. 16) is above a timing difference threshold. In an example, the value of timing difference threshold may be RRC configured. In an example, the UE may signal to the eNB in a capability message on the minimum amount of time it requires to process the power control scaling factors in a CG with a later transmission after transmission on a set of carriers in a CG with an earlier transmission has started. In an example, the eNB may consider the UE capabilities to configure the timing difference threshold.

In an example embodiment, the UE may not consider LBT success or failure on the set of LAA carriers in CG₂ on which transmission is attempted in subframe i₁−1 in order to apply power scaling rules for transmissions on the set of carriers in CG₂ that are scheduled for transmission in subframe i₂.

In an example embodiment, the wireless device may use a method comprising receiving by the wireless device at least one message comprising configuration parameters of a plurality of cells from a first base station. The plurality of cells may be grouped as a first cell group and a second cell group. In an example, the wireless device may receive one or more first grants for transmission in a first subframe on one or more first cells of the first cell group. The wireless device may receive one or more second grants for transmission in a second subframe on one or more second cells of the second cell group where the first subframe overlaps the second subframe. The wireless device may apply a power scaling rule to transmissions on the second subframe based at least in part, on whether a listen before talk (LBT) procedure is successful. In an example, the one or more first cells of the first cell group may comprise at least one LAA cell. In an example, the LBT procedure may be for one of the at least one LAA cell. In an example, overlap between the first subframe and the second subframe may depend on a timing difference. In an example, the power scaling rule may be applied, at least in part, based on whether the timing difference is greater than a threshold. In an example, the at least one message may further comprise an information element indicating a value for the threshold. In an example, the wireless device may transmit to the base station at least one message comprising a minimum scaling factor processing time value.

In an example embodiment, the wireless device may use a method comprising receiving at least one message comprising configuration parameters of a plurality of cells. The plurality of cells may be grouped into a first cell group and a second cell group. The wireless device may transmit a first signal in a first subframe in the first cell group. The wireless device may transmit a second signal in a second subframe of the second cell group. The first subframe may overlap in time with the second subframe. The power calculation of the second signal may depend on whether listen before talk (LBT) for the first signal is successful or not.

In an example embodiment, in asynchronous dual connectivity comprising cell groups 1 and 2 (e.g., CG₁ and CG₂ respectively), the CG₁ and CG₂ may include one or more LAA cells. In an example, one or more grants for transmission on one or more LAA cells of a cell group (e.g., CG₂) may arrive more than four subframes before its scheduled transmission. In an example, the one or more grants may comprise two-stage grants and/or one-stage grant with timing offset leading to more than 4 subframes from the actual grant reception subframe to the scheduled transmission subframe.

In an example embodiment, after a UE receives one or more grant for transmission on one or more cell of CG₁ on subframe i₁ and when the UE calculates power levels of signals and/or channels to be transmitted on subframe i₁ on the scheduled cells of the CG₁, the UE may have processed one or more grant(s) that schedule transmission in one or more LAA cells of CG₂ in subframe i₂ (which, for example, may have arrived more than four subframes before subframe i₂) and may have calculated the power for corresponding transmissions in subframe i₂ of the CG₂. The UE may have processed the grants for cells of CG₂ transmitting in subframe i₂−1 and may have calculated the power for corresponding transmissions in subframe i₂−1 of the CG₂.

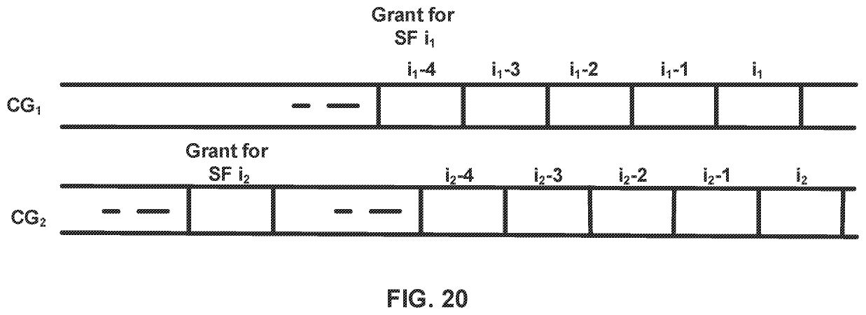

In an example embodiment, when the UE calculates the transmission power of signals and channels of a cell group to be transmitted in a subframe (e.g., subframe i₁ in FIG. 20), and the power of signals and/or channels in the latter overlapping subframe of the other cell group (e.g., subframe i₂ in FIG. 20) are partly or completely calculated, the UE may consider the calculated power of signals and/or channels in the latter overlapping subframe of the other cell group in its transmission power calculations for the subframe (e.g., subframe i₁ in FIG. 20). In an example, when the UE calculates the transmission power of signals and channels of a cell group to be transmitted in a subframe (e.g., subframe i₁ in FIG. 20), the grants for the former overlapping subframe of the other cell group (e.g., subframe i₂−1 in FIG. 20) may have been processed and the power of its signals and/or channels may have been calculated and the UE may consider the calculated power of signals and/or channels of the former overlapping subframe of the other cell group in its transmission power calculations for the subframe (e.g., subframe i₁ in FIG. 20). In an example in FIG. 20, the UE may have processed one or more grants for transmission on subframe i₂ of CG₂ for one or more cells of CG₂. In an example, the one or more cells of CG₂ whose grant(s) has(have) been processed may be LAA cell(s).

In a non-limiting example, if the UE determines based on higher layer signaling that transmission(s) in subframe i₁ of CG1 may not overlap in time with transmission(s) in subframe i₂ of CG2, the UE may determine

$${\hat{P}}_{CG 1}^{1} ( i 1 ) = min \{ \begin{matrix}{\hat{P}}_{q 1} ( i 1 ) , \\ \begin{matrix}{\hat{P}}_{CMAX} ( i 1 , i 2 - 1 ) - {\hat{P}}_{PRACH \_ CG 1} ( i 1 ) - \\ {\hat{P}}_{CG 2}^{1} ( i 2 - 1 ) - {\hat{P}}_{PRACH \_ CG 2} ( i 2 - 1 )\end{matrix}\end{matrix} \} ,$$

otherwise, the UE may determine

$${\hat{P}}_{CG 1}^{1} ( i 1 ) = min \{ \begin{matrix}{\hat{P}}_{q 1} ( i 1 ) , \\ \begin{matrix}{\hat{P}}_{CMAX} ( i 1 , i 2 - 1 ) - {\hat{P}}_{PRACH \_ CG 1} ( i 1 ) - \\ max \{ \begin{matrix}{\hat{P}}_{CMAX} ( i 1 , i 2 - 1 ) \frac{{γ}_{CG 2}}{100} \\ {\hat{P}}_{CG 2}^{1} ( i 2 - 1 ) + {\hat{P}}_{PRACH \_ CG 2} ( i 2 - 1 ) \\ {\hat{P}}_{CG 2}^{1} ( i 2 ) + {\hat{P}}_{PRACH \_ CG 2} ( i 2 )\end{matrix} \}\end{matrix}\end{matrix} \}$$

where \hat{P}_{CG2}¹(i2) may be the calculated PUSCH, PUCH and SRS power for subframe i₂ of CG₂ for example for the cells of CG₂ whose power have been calculated. Other equations may be used.

In an example embodiment, a wireless device may use a method comprising: receiving at least one message comprising configuration parameters of a plurality of cells. The plurality of cells may be grouped into a first cell group and a second cell group. The wireless device may transmit one or more first signals in a first subframe in the first cell group. The wireless device may transmit one or more second signals in a second subframe of the second cell group. The wireless device may transmit one or more third signals in a third subframe of the second cell group. The second and third subframes may overlap with the first subframe. The power calculation of the one or more first signal may depend on the one or more second signals and the one or more third signal based at least in part, on whether a grant is received more than k subframe is advance. In an example, k may be 5.

In an example embodiment, the wireless device may use a method comprising: receiving, by a wireless device from a first base station, at least one message comprising configuration parameters of a plurality of cells. The plurality of cells may be grouped as a first cell group and a second cell group. The wireless device may receive one or more first grants for transmission in a first subframe on one or more cells of the first cell group. The wireless device may receive one or more second grants for transmission in a second subframe on one or more cells of the second cell group. The wireless device may receive one or more third grants for transmission in a third subframe. The second subframe may be adjacent to the third subframe. The first subframe may overlap the second subframe and third subframe. The wireless device may apply a power calculation for transmissions of the first subframe, based at least in part, on a calculated power of transmission in the second and third subframe when at least one of the one or more third grants received at least k subframes before the third subframe. In an example k may be 5. In an example, the at least one of the at least one or more third grants may be an LAA grant. In an example, the LAA grant may be a multiple stage grant. In an example, the multiple stage grant may be a two-stage grant. In an example, the LAA grant may be a two-stage grant. In an example, the LAA grant may be a one-stage grant with a timing offset.

According to various embodiments, a device (such as, for example, a wireless device, off-network wireless device, a base station, and/or the like), may comprise one or more processors and memory. The memory may store instructions that, when executed by the one or more processors, cause the device to perform a series of actions. Embodiments of example actions are illustrated in the accompanying figures and specification. Features from various embodiments may be combined to create yet further embodiments.

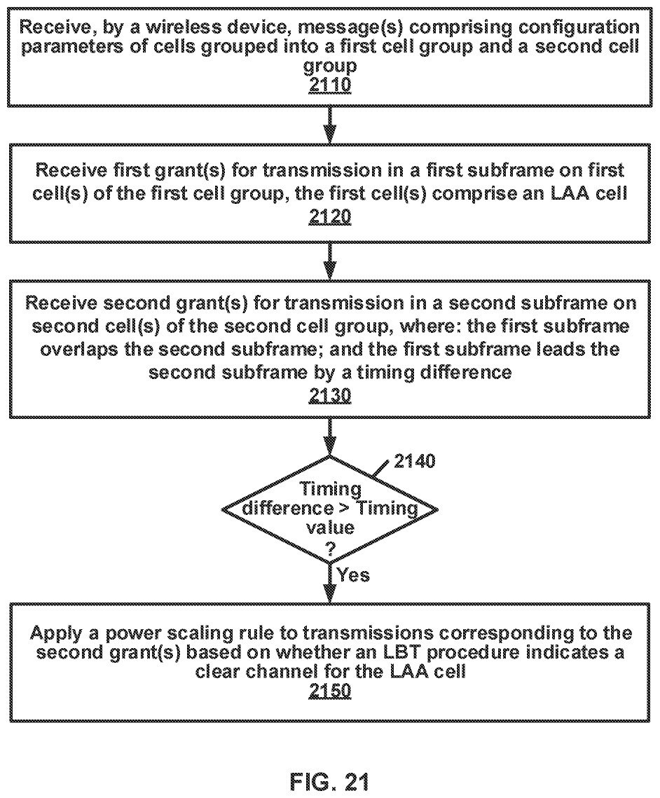

FIG. 21 is an example flow diagram as per an aspect of an embodiment of the present disclosure. A wireless device may receive one or more messages at 2110. The one or more messages may comprise configuration parameters of a plurality of cells grouped into a first cell group and a second cell group. At 2120, the wireless device may receive one or more first grants for transmission in a first subframe on one or more first cells of the first cell group. The one or more first cells may comprise a licensed assisted access (LAA) cell. At 2130, one or more second grants for transmission in a second subframe on one or more second cells of the second cell group may be received. The first subframe may overlap the second subframe. The first subframe may lead the second subframe by a timing difference. In response to the timing difference being larger than a timing value (determined at 2140), a power scaling rule may be applied to transmissions corresponding to the one or more second grants based on whether a listen before talk procedure indicates a clear channel for the LAA cell at 2150.

According to an embodiment, a total determined transmission power for uplink transmission in the second subframe may exceed a first power value. According to an embodiment, the power scaling rule may employ a determined power of the LAA cell in response to the listen before talk procedure indicating a clear channel. The power scaling rule may not employ the determined power of the LAA cell in response to the listen before talk procedure not indicating a clear channel. According to an embodiment, the first cell group and the second cell group may operate in an asynchronous mode. According to an embodiment, the one or more messages may indicate the timing value. According to an embodiment, the wireless device may further transmit a capability message indicating a time duration value for processing power scaling factors. According to an embodiment, the one or more second cells may comprise a second LAA cell. According to an embodiment, the scaling rule may be independent of whether a listen before talk procedure indicates a clear channel for the second LAA cell. According to an embodiment, the power scaling rule may employ a determined power of uplink transmission via the second LAA cell. According to an embodiment, the one or more first cells may be synchronous and the one or more second cells may be synchronous.

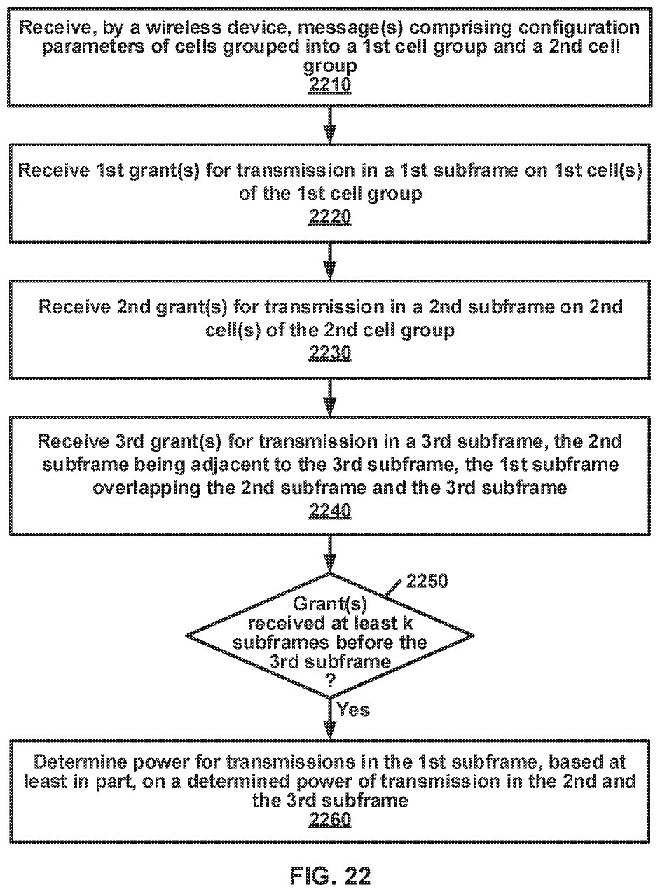

FIG. 22 is an example flow diagram as per an aspect of an embodiment of the present disclosure. At 2210, a wireless device may receive at least one message. The at least one message may comprise configuration parameters of a plurality of cells grouped into a first cell group and a second cell group. At 2220, one or more first grants for transmission in a first subframe on one or more first cells of the first cell group may be received. At 2230, one or more second grants for transmission in a second subframe on one or more second cells of the second cell group may be received. At 2240, one or more third grants for transmission in a third subframe may be received. The second subframe may be adjacent to the third subframe. The first subframe may overlap the second subframe and the third subframe. At 2256, power for transmissions in the first subframe may be determined, based at least in part, on a determined power of transmission in the second and the third subframe when at least one of the one or more third grants are received at least k subframes before the third subframe (determined at 2250). According to an embodiment, k may be equal to five.

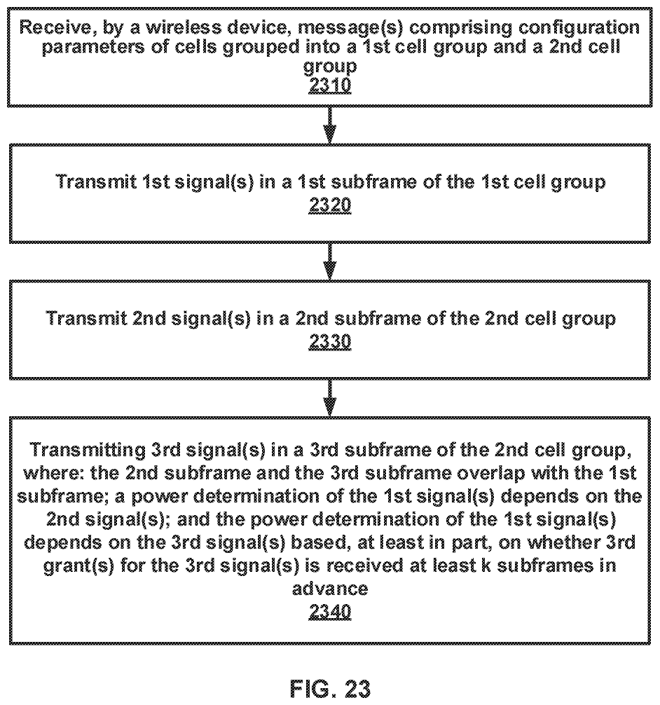

FIG. 23 is an example flow diagram as per an aspect of an embodiment of the present disclosure. At 2310, a wireless device may receive one or more messages. The one or more messages may comprise configuration parameters of a plurality of cells grouped into a first cell group and a second cell group. At 2320, one or more first signals in a first subframe of the first cell group may be transmitted. At 2330, one or more second signals in a second subframe of the second cell group may be transmitted. At 2340, one or more third signals in a third subframe of the second cell group may be transmitted. The second subframe and the third subframe may overlap with the first subframe. A power determination of the one or more first signals may depend on the one or more second signals. The power determination of the one or more first signals may depend on the one or more third signals based, at least in part, on whether a grant for the one or more third signals is received at least k subframes in advance. According to an embodiment, k may be equal to five.

In this specification, “a” and “an” and similar phrases are to be interpreted as “at least one” and “one or more.” In this specification, the term “may” is to be interpreted as “may, for example.” In other words, the term “may” is indicative that the phrase following the term “may” is an example of one of a multitude of suitable possibilities that may, or may not, be employed to one or more of the various embodiments. If A and B are sets and every element of A is also an element of B, A is called a subset of B. In this specification, only non-empty sets and subsets are considered. For example, possible subsets of B={cell1, cell2} are: {cell1}, {cell2}, and {cell1, cell2}.

In this specification, parameters (Information elements: IEs) may comprise one or more objects, and each of those objects may comprise one or more other objects. For example, if parameter (IE) N comprises parameter (IE) M, and parameter (IE) M comprises parameter (IE) K, and parameter (IE) K comprises parameter (information element) J, then, for example, N comprises K, and N comprises J. In an example embodiment, when one or more messages comprise a plurality of parameters, it implies that a parameter in the plurality of parameters is in at least one of the one or more messages, but does not have to be in each of the one or more messages.

Many of the elements described in the disclosed embodiments may be implemented as modules. A module is defined here as an isolatable element that performs a defined function and has a defined interface to other elements. The modules described in this disclosure may be implemented in hardware, software in combination with hardware, firmware, wetware (i.e. hardware with a biological element) or a combination thereof, all of which are behaviorally equivalent. For example, modules may be implemented as a software routine written in a computer language configured to be executed by a hardware machine (such as C, C++, Fortran, Java, Basic, MATLAB or the like) or a modeling/simulation program such as Simulink, Stateflow, GNU Octave, or LabVIEWMathScript. Additionally, it may be possible to implement modules using physical hardware that incorporates discrete or programmable analog, digital and/or quantum hardware. Examples of programmable hardware comprise: computers, microcontrollers, microprocessors, application-specific integrated circuits (ASICs); field programmable gate arrays (FPGAs); and complex programmable logic devices (CPLDs). Computers, microcontrollers and microprocessors are programmed using languages such as assembly, C, C++ or the like. FPGAs, ASICs and CPLDs are often programmed using hardware description languages (HDL) such as VHSIC hardware description language (VHDL) or Verilog that configure connections between internal hardware modules with lesser functionality on a programmable device. Finally, it needs to be emphasized that the above-mentioned technologies are often used in combination to achieve the result of a functional module.

The disclosure of this patent document incorporates material which is subject to copyright protection. The copyright owner has no objection to the facsimile reproduction by anyone of the patent document or the patent disclosure, as it appears in the Patent and Trademark Office patent file or records, for the limited purposes required by law, but otherwise reserves all copyright rights whatsoever.

While various embodiments have been described above, it should be understood that they have been presented by way of example, and not limitation. It will be apparent to persons skilled in the relevant art(s) that various changes in form and detail can be made therein without departing from the spirit and scope. In fact, after reading the above description, it will be apparent to one skilled in the relevant art(s) how to implement alternative embodiments. Thus, the present embodiments should not be limited by any of the above described exemplary embodiments. In particular, it should be noted that, for example purposes, the above explanation has focused on the example(s) using LAA communication systems. However, one skilled in the art will recognize that embodiments of the disclosure may also be implemented in a system comprising one or more TDD cells (e.g. frame structure 2 and/or frame structure 1). The disclosed methods and systems may be implemented in wireless or wireline systems. The features of various embodiments presented in this disclosure may be combined. One or many features (method or system) of one embodiment may be implemented in other embodiments. Only a limited number of example combinations are shown to indicate to one skilled in the art the possibility of features that may be combined in various embodiments to create enhanced transmission and reception systems and methods.

In addition, it should be understood that any figures which highlight the functionality and advantages, are presented for example purposes only. The disclosed architecture is sufficiently flexible and configurable, such that it may be utilized in ways other than that shown. For example, the actions listed in any flowchart may be re-ordered or only optionally used in some embodiments.

Further, the purpose of the Abstract of the Disclosure is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The Abstract of the Disclosure is not intended to be limiting as to the scope in any way.

Finally, it is the applicant's intent that only claims that include the express language “means for” or “step for” be interpreted under 35 U.S.C. 112. Claims that do not expressly include the phrase “means for” or “step for” are not to be interpreted under 35 U.S.C. 112.

What is claimed is:

1. A method comprising:
receiving, by a base station, a message indicating a minimum amount of time for a wireless device to perform a power adjustment, wherein the wireless device is configured to support communication via at least two cell groups; and
based on the message, transmitting a configuration message indicating a threshold timing difference, between a first time duration of a first cell group, of the at least two cell groups, and an overlapping second time duration of a second cell group, of the at least two cell groups, for performing the power adjustment.

2. The method of claim 1, further comprising:
determining, based on the received message, one or more capabilities of the wireless device; and
determining, based on the one or more capabilities of the wireless device, the threshold timing difference.

3. The method of claim 1, wherein the configuration message is a radio resource control (RRC) message.

4. The method of claim 1, wherein the at least two cell groups comprise at least one of a licensed assisted access (LAA) cell, an unlicensed cell, or combinations thereof.

5. The method of claim 1, wherein the configuration message comprises a value of the threshold timing difference.

6. The method of claim 1, wherein the configuration message comprises an indication of a minimum power scaling factor processing time value.

7. The method of claim 1, wherein the received message comprises an indication of a time duration value for processing a power scaling factor.

8. A base station comprising:
one or more processors; and
memory storing instructions that, when executed, configure the base station to:
receive a message indicating a minimum amount of time for a wireless device to perform a power adjustment, wherein the wireless device is configured to support communication via at least two cell groups; and
based on the received message, transmit a configuration message indicating a threshold timing difference, between a first time duration of a first cell group, of the at least two cell groups, and an overlapping second time duration of a second cell group, of the at least two cell groups, for performing the power adjustment.

9. The base station of claim 8, wherein the instructions, when executed, further cause the base station to:
determine, based on the received message, one or more capabilities of the wireless device; and
determine, based on the one or more capabilities of the wireless device, the threshold timing difference.

10. The base station of claim 8, wherein the configuration message is a radio resource control (RRC) message.

11. The base station of claim 8, wherein the at least two cell groups comprise at least one of a licensed assisted access (LAA) cell, an unlicensed cell, or combinations thereof.

12. The base station of claim 8, wherein the configuration message comprises a value of the threshold timing difference.

13. The base station of claim 8, wherein the configuration message comprises an indication of a minimum power scaling factor processing time value.

14. The base station of claim 8, wherein the received message comprises an indication of a time duration value for processing a power scaling factor.

15. A system comprising:
a base station; and
a wireless device configured to support communication via at least two cell groups;
wherein the wireless devices is configured to transmit a message indicating a minimum amount of time for the wireless device to perform a power adjustment; and
wherein the base station is configured to, based on the received message, transmit a configuration message indicating a threshold timing difference, between a first time duration of a first cell group, of the at least two cell groups, and an overlapping second time duration of a second cell group, of the at least two cell groups, for performing the power adjustment.

16. The system of claim 15, wherein the base station is further configured to:
determine, based on the received message, one or more capabilities of the wireless device; and
determine, based on the one or more capabilities of the wireless device, the threshold timing difference.

17. The system of claim 15, wherein the configuration message is a radio resource control (RRC) message.

18. The system of claim 15, wherein the at least two cell groups comprise at least one of a licensed assisted access (LAA) cell, an unlicensed cell, or combinations thereof.

19. The system of claim 15, wherein the configuration message comprises a value of the threshold timing difference.

20. The system of claim 15, wherein the configuration message comprises an indication of a minimum power scaling factor processing time value.

21. The system of claim 15, wherein the received message comprises an indication of a time duration value for processing a power scaling factor.
